(19) United States
(12) Patent Application Publication
(10) Pub. No.: US 2008/0052337 A1
(43) Pub. Date: Feb. 28, 2008

(54) Technique and program code constituting use of local-global solution (LOGOS) modes for sparse direct representations of wave-like phenomena

(75) Inventor: Robert J. Adams, Lexington, KY (US)

Correspondence Address: JEAN M. MACHELEDT, 501 SKYSAIL LANE, SUITE B100, FORT COLLINS, CO, 80525-3133, US

(73) Assignee: University of Kentucky Research Foundation

(21) Appl. No.: 11/799,997

(22) Filed: May 2, 2007

Related U.S. Application Data
(60) Provisional application No. 60/797,011, filed on May 2, 2006.

(51) Int. Cl. G06F 7/38

(52) U.S. Cl. 708/446

(57) ABSTRACT

A technique for implementation employing a computerized device and associated computer executable program code, for obtaining a direct solution of a linear system of equations, comprising a unique routine. The method can be employed for characterizing wave phenomena—of the electromagnetic and acoustic type—to aid in the design of a structure around which the wave phenomena will scatter; the method is useful for linear system of equations consisting of a plurality of sparse matrix equations, and a plurality of compressed representations of full matrix equations. The routine includes: using a plurality of solution modes, J, that are localized to a subdomain of a larger simulation domain, the plurality of solution modes also satisfying an original system equation of the form: ZJ=Eⁱ, where Z represents an impedance matrix, and Eⁱ represents a forcing vector. Using a basis of local solutions that satisfy the original system equation, ZJ=Eⁱ, a plurality of compressed representations of solution operators can be obtained comprising a product of matrices, (A₁ A₂ . . . Aₙ), wherein each Aᵢ represents a matrix having been derived from information taken from the matrix Z, such that J=(A₁ A₂ . . . Aₙ) Eⁱ; the plurality of solution modes, J, having been obtained from a plurality of forcing vectors, Eⁱ. Both ‘non-radiating’ and ‘radiating’ scenarios are contemplated.

This application claims the benefit of pending U.S. provisional patent application No. 60/797,011 filed 02 May 2006 for the applicant on behalf of the assignee hereof, the specification and associated drawings of this provisional application are incorporated herein by reference, providing background technical support to the extent consistent herewith.

The invention disclosed herein was made with U.S. government support awarded by the following agencies: Office of Naval Research (ONR), under contract number N00014-04-0485; and National Science Foundation (NSF) award number ECS-0547497. Accordingly, the U.S. Government has certain rights in this invention.

### BACKGROUND OF THE INVENTION

### Field of the Invention

In general, the present invention relates to computerized techniques for determining, solutions for electromagnetic (EM) scattering from surfaces of structures/objects such as those encountered when designing systems for the transmission and receipt of EM radiation/waves. The invention also relates to computerized techniques for determining solutions for other types of wave phenomena, such as acoustic, scattering from surfaces of structures/objects. More particularly, the novel technique is directed to assist in performing modeling, design, and analysis of wave phenomena—in an effort to characterize associated fields—as is done in, the design and implementation of whole system and modular approaches used in connection with characterizing transmission and/or receipt of radiation/wave phenomena.

While there are existing sparse direct solvers, they are limited in application. None of the existing sparse direct solvers employ the unique local/global framework disclosed hereby—which quite uniquely—is adapted to analyze and characterize wave phenomena scattering in both sparse systems (for which existing sparse direct solvers are directed, but, solutions are more-computer resource driven, bulky manner), and compressed-full linear systems (which existing sparse direct solvers cannot effectively address). This unique local/global framework (LOGOS) uses a basis of local solutions that satisfy the global system equation to obtain compressed representations of solution operators, identified as a product of matrices, (A₁ A₂ . . . Aₙ) which, upon multiplying the excitation (or forcing) vector, Eⁱ, yield the desired solution of the linear system. The LOGOS framework comprises the computerized implementation of a compressed, direct solution of a linear system of equations using a basis of solution modes (i.e., sources, J) that are effectively localized to a subdomain of a larger simulation domain, which modes also satisfy the original system equation (here, generally as ZJ=Eⁱ) and, in some cases, an auxiliary set of constraint equations. The novel direct solution methods contemplated herein for the linear matrix equation Z J=Eⁱ represent the solution, J, as a product of matrices multiplying (or ‘operating on’) the forcing vector, Eⁱ. Direct solution methods satisfy the following property. The desired solution vector(s)/mode(s), J, can be obtained from Eⁱ as a finite product of matrices—i.e., ‘solution operators’ (A₁A₂ . . . Aₙ)—that multiply Eⁱ, viz.,
J=(A₁ A₂ . . . Aₙ)Eⁱ
The matrices, Aᵢ, are derived from information in the matrix Z (and possibly also additional, supplementing information). Distinguishable from the unique direct solution techniques contemplated herein, are traditional direct solution methods, for example:
An LU factorization [1] is obtained by first computing the factorization Z=LU where L and U are lower and upper triangular matrices, respectively. In this case, the desired solution is obtained with n=2, and A₁=U⁻¹ and A₂=L⁻¹. The operations indicated by L⁻¹ and U⁻¹ are typically implemented via forward and backward substitution procedures, though one might also explicitly form the indicated inverse matrices, see below.
A second, direct representation is obtained by explicitly forming L⁻¹ and U⁻¹ and multiplying the resulting matrices together. In this case, n=1 and A₁=(U⁻¹L⁻¹). Unlike iterative solution methods, the number of operations required by a direct solution procedure can often be determined a priori for an arbitrary excitation vector.

Below is a non-exhaustive list of applications in which the novel technique contemplated herein may be employed in connection with characterizing wave phenomena for a wide variety of uses:
Analyzing and designing electromagnetic devices and systems (e.g., antennae)
Analyzing and designing acoustic devices and systems
Electromagnetic radiation modeling and design
Electromagnetic scattering analysis
Electromagnetic target recognition
Inverse electromagnetic scattering
Inverse acoustic scattering
Medical imaging
Remote sensing,
Microwave engineering
Optoelectronic device design and analysis
Electromagnetic compatibility and interference analysis
Integrated circuit modeling and design
Real-time electromagnetic scene modeling
Real-time acoustic scene modeling
Wireless channel modeling
Development of modular electromagnetic design and analysis tools for the preceding-listed technological areas.

As one can appreciate, to date, relatively little progress has been made in developing useful, more-generally applicable fast ‘direct solution’ strategies for CEM applications. While some of the initial, more-pioneering work in this area was done by Francis X. Canning—his work is described in U.S. Pub. App. No. 2004/0078174 Al (Apr. 22, 2004) entitled Sparse and Efficient Block Factorization for Interaction Data and U.S. Pub. App. No. 2004/0010400 A1 (Jan. 15, 2004) entitled Compression of Interaction Data Using Directional Sources and/or Testers—the instant invention is quite distinguishable from these earlier approaches.

1. Introduction

Computational Electromagnetics (CEM). CEM is the term giving to the science of numerically solving a complex set of Maxwell's equations using available computer, resources, which may be limited. The solutions describe the physical interactions and phenomena between charged particles, or other media that exhibits wave phenomena behavior, and materials or objects/structures. Electromagnetic (EM) fields are governed by Maxwell's equations, and except for a few simple geometries, such as spheres and cylinders, these equations cannot be solved analytically.

Sparse direct solvers for sparse linear systems. While others have identified and applied direct solvers for sparse linear systems of equations (sometimes simply referred to as: ‘sparse direct solvers’), these prior efforts have been focused on sparse matrix equations that have resulted from analyzing a sparse system of linear equations, as opposed to the dense matrix equations encountered when finding solutions to the integral equations which represent the complex nature of wave phenomena scattering from structures/objects, such as is the case when working with Maxwell's equations. The term ‘direct solution’ in this general context, refers to a technique for solving a system of equations that relies on linear algebra, directly.

For the dense systems associated with integral equation models, such as those encountered when analyzing complex CEM wave phenomena (e.g., scattering of EM emissions from an antenna atop a moving vehicle, e.g., watercraft, plane, or jet) while the first step is to compress (or determine a compressed representation of) the governing full matrix equation in a manner similar to that done in U.S. Pub. App. No. 2004/0010400 A1 (Jan. 15, 2004) entitled Compression of Interaction Data Using Directional Sources and/or Testers, F. E X. Canning, attempting to employ traditional/existing techniques for factoring sparse matrix equations to the resulting compressed (sometimes referred to as ‘data sparse’) representations of the full matrices associated with integral equations, does not work. An n-by-m matrix is a rectangular array of n×m numbers generally arranged as follows: n horizontal rows and m vertical columns. A vector is a special case matrix that occurs when either n or m (i.e., either the row or column) is equal to one. Matrices are used in applications for solving systems of linear equations.

Surprisingly, the unique factoring technique associated with the local/global framework disclosed hereby, works with both sparse and compressed-full linear systems: This new framework permits factoring of compressed representations of full matrices, and can be employed to factor the sparse matrices obtained from PDE-based (i.e., sparse because these matrices have a majority of elements equal to zero) representations of Maxwell's equations—the resulting unique factorization algorithms outperform existing sparse direct solvers. While existing sparse direct solvers, though useful to a degree and limited to addressing sparse system problems, are recognized to require O(Nˆ2) CPU (computer processing unit) time for large problems, the novel solvers comprising the unique local/global framework disclosed hereby, require O(N log N) CPU time in many cases of practical interest.

2. General Discussion of: Computerized Devices, Memory & Storage Devices/Media.

I. Digital computers. A processor is the set of logic devices/circuitry that responds to and processes instructions to drive a computerized device. The central processing unit (CPU) is considered the computing part of a digital or other type of computerized system. Often referred to simply as a processor, a CPU is made up of the control unit, program sequencer, and an arithmetic logic unit (ALU)—a high-speed circuit that does calculating and comparing. Numbers are transferred from memory into the ALU for calculation, and the results are sent back into memory. Alphanumeric data is sent from memory into the ALU for comparing. The CPUs of a computer may be contained on a single ‘chip’, often referred to as microprocessors because of their tiny physical size. As is well known, the basic elements of a simple computer include a CPU, clock and main memory; whereas a complete computer system requires the addition of Control units input, output and storage devices, as well as an operating system. The tiny devices referred to as ‘microprocessors’ typically contain the processing components of a CPU as integrated circuitry, along with associated bus interface. A microcontroller typically incorporates one or more microprocessor, memory, and I/O circuits as an integrated circuit (IC). Computer instruction(s) are used to trigger computations carried out by the CPU.

II. Computer Memory and Computer Readable Storage. While the word ‘memory’ has historically referred to that which is stored temporarily, with storage traditionally used to refer to a semi-permanent or permanent holding place for digital data—such as that entered by a user for holding long term—more-recently, the definitions of these terms have blurred. A non-exhaustive listing of well known computer readable storage device technologies are categorized here for reference: (1) magetic tape technologies; (2) magnetic disk technologies include floppy disk/diskettes, fixed hard disks (often in desktops, laptops, workstations, etc.),, (3) solid-state disk (SSD) technology including DRAM and ‘flash memory’; and (4) optical disk technology, including magneto-optical disks, PD, CD-ROM, CD-R, CD-RW, DVD-ROM, DVD-R, DVD-RAM, WORM, OROM, holographic, solid state optical disk technology, and so on.

III. Electromagnetic waves. It is well known that electric and magnetic fields are fundamentally fields of force that originate from electric charges. Whether a force field may be termed electric, magnetic, or electromagnetic (EM) hinges on the motional state of the electric charges relative to the point at which field observations are made. Electric charges at rest relative to an observation point give rise to an electrostatic (time-independent) field there. The relative motion of the charges provides an additional force field called magnetic. That added field is magnetostatic if the charges are moving at constant velocities relative to the observation point. Accelerated motion of charges produces both time-varying electric and magnetic fields, or electromagnetic fields. Exposure of a time-varying, typically sinusoidal magnetic field will induce an associated time-varying current (‘alternating current’ or ‘ac’/‘AC’) in a ferromagnetic sample such that it will emit EM energy.

### SUMMARY OF THE INVENTION

It is a primary object to provide a technique for implementation employing a computerized device and associated computer executable program code on a computer readable storage medium, for obtaining a direct solution of a linear system of equations, comprising a unique routine. The method can be employed for characterizing wave phenomena—of the electromagnetic and acoustic type—to aid in the design of a structure around which the wave phenomena will scatter; the method is useful for linear system of equations consisting of a plurality of sparse matrix equations, and a plurality of compressed representations of full matrix equations.

The new routine includes: using a plurality of solution modes, J, that are localized to a subdomain of a larger simulation domain, the plurality of solution modes also satisfying an original system equation of the form: ZJ=Eⁱ, where Z represents an impedance matrix, and Eⁱ represents a forcing vector. Using a basis of local solutions that satisfy the original system equation, ZJ=Eⁱ, a plurality of compressed representations of solution operators can be obtained comprising a product of matrices, (A₁ A₂ . . . Aₙ), wherein each Aⁱ represents a matrix having been derived from information taken from the matrix Z, such that J=(A₁ A₂ . . . Aₙ) Eⁱ; the plurality of solution modes, J, having been obtained from a plurality of forcing vectors, Eⁱ.

Both ‘non-radiating’ and ‘radiating’ scenarios are contemplated: Where the plurality of localized solution modes, J, are constrained for a generally non-radiating scenario, the solution modes, J, will radiate a negligible amount of energy to a plurality of spatial regions that are both (i) inside a simulation domain, and (ii) outside of a localized spatial region to which the solution modes, J, have been so localized. Where the plurality of localized solution modes, J, are constrained for a generally radiating scenario, the solution modes, J, will radiate a non-negligible amount of energy to a plurality of spatial regions that are outside of a localized spatial region to which the solution modes, J, have been so localized.

Further aspects of the generally non-radiating scenario, include:

Each of the plurality of localized solution modes, J, is associated with a respective localized spatial region, and each adjacent region of said respective localized spatial regions, overlap; and

Each of the plurality of localized solution modes, J, is associated with a respective localized spatial region, and computed from a compressed representation of a full matrix for the original system equation.

Further aspects of the generally radiating scenario, include:

Each of a respective field so radiated and associated with a respective of the plurality of localized solution modes, J, is represented using a plurality of plane waves propagating in a plurality of directions.

The routine can further include: using the plurality of localized solution modes, J, to compress a system response, associated with the original system equation, ZJ=Eⁱ, to a plurality of plane wave excitations associated with a wave phenomena.

The routine can further include.: using a pseudo-inverse of the discrete plane wave transform, D⁺, to obtain a compressed representation of a system response, associated with the original system equation, ZJ=Eⁱ, to a plurality of plane wave excitations associated with the wave phenomena, as well as a system response to simply the wave phenomena.

One will appreciate the distinguishable features of the techniques and associated program code described herein from those of known computerized linear system solution techniques, including prior attempts by other to create electromagnetic wave system solution analysis and design tools. Certain of the unique features, and further unique combinations of features—as supported and contemplated—may provide one or more of a variety of advantages, among which include: (a) flexibility/versatility in new system design and integration; (b) reliable investigation and analysis of current systems affected by wave phenomena; and (c) handy integration of the technique and program code employing computer equipment/systems currently available.

### BRIEF DESCRIPTION OF DRAWINGS, EXAMPLES, and ATTACHMENTS

For purposes of illustrating the innovative nature plus the flexibility of design and versatility of the new technique set forth herein, the following several EXAMPLES are included (similar to those set forth in respectively labeled Sections of applicant's provisional application—within each EXAMPLE are respectively labeled expressions and internal diagrams): EXAMPLES 1, 1.2, 1.3, 1.4, and 1.5 are set forth within the DETAILED DESCRIPTION OF EMBODIMENTS section; and EXHIBITS A; B, and C—respectively, containing text and graphics numbered EXAMPLE 2, 3, and 4—are manuscripts authored by the applicant, included herewith to provide further detail of rigorous engineering and mathematical analyses associated, respectively, with EXAMPLES 1.2, 1.3, and 1.4. One can readily appreciate the advantages as well as novel features that distinguish the instant invention from conventional systems and techniques. The figures as well as the incorporated technical materials have been included to communicate the features of applicant's innovative technique by way of example, only, and are in no way intended to limit the disclosure hereof. Any identified reference, is hereby incorporated herein by reference for purposes of providing background technical information.

FIG. 1 A high-level flow diagram 10 depicting features of a direct solution strategy, see also FIG. 1 of Example #4 manuscript set forth, as labeled, EXHIBIT C.

FIG. 2 A high-level flow diagram 20 depicting LOGOS-based factorization of, an MLSSM representation of Z, see also FIG. 7 of Example #4 manuscript set forth, as labeled, EXHIBIT C.

FIG. 3 A graphical representation of a two-level quad-tree decomposition of a: general scatterer in two dimensions, see also FIG. 2 of Example #4 manuscript set forth, as labeled, EXHIBIT C.

FIG. 4 A graphical illustration of the concept of overlapped LOGOS modes. The grid of rectangles shown represent different groups at a given level of a quad-tree decomposition (represented by FIG. 3 hereof). The black shaded block represents a particular ‘self-group’, and the gray shaded blocks represent the self-group's near-neighbors. For the self-group so indicated: one can see that an overlapped, localizing LOGOS (OLL) mode has been defined, here it is an electrical current (represented in the system integral equation as J) that is generally nonzero in all the shaded blocks (self- and near-neighbor), and which produces a scattered field, ZJ, that is nonzero only within the self-group (to O(ε)), see also FIG. 3 of Example #4 manuscript set forth, as labeled, EXHIBIT C.

FIG. 5 A graphical depiction of the general structure of the overlapped LOGOS transformation matrix, Λₗ. The structure of the decomposition is illustrated in the figure, with the nondiagonal, localizing submatrix Λₗ^{(L)} appearing on the left, and the block diagonal, nonlocalizing submatrix Λₗ^{(N)} on the right; see also FIG. 4 (Example #4) manuscript set forth, as labeled, EXHIBIT C.

FIG. 6 An illustration of the decomposition of a general target into two non-overlapping spatial regions. The smaller section (S₁) is referred to in the text as “Region 1”, and the larger section (S₂ ) is referred to as “Region 2”.

FIG. 7 An illustration of localized electrical current (current being generally represented in the system integral equation as J) and global incident/scattered fields on surface of a PEC target.

FIGS. 8A and 8B FIG. 8A is an illustration representing an array of dihedral PEC cylinders. FIG. 8B is an enlargement of a single element from FIG. 8A. The. numbers of array elements in x,y-directions are designated Nₓ and N_{y}. The spacing between array elements is 0.4 L, where L is the length of one side of an array element; configuration, can be expressed as N_{y}=2Nₓ+1. The thickness of each array element is zero. For all L, each individual array element is discretized using 10 facets. See also reference made to dimensions found in FIG. 1 Example #2 manuscript set forth, as labeled, EXHIBIT A.

FIG. 9 A graphical depiction of a sparsity pattern of transformed impedance matrix, \hat{Z}, for the array -depicted in FIG. 8A when e=0.001 and L=0.1l, Nₓ=8, N_{y}=17. Blacked areas indicate nonzero matrix entries. A five level tree was used to, decompose the smallest square containing the dihedral array. See also FIG. 2 Example #2 manuscript set forth, as labeled, EXHIBIT A.

FIGS. 10A and 10B FIG. 10A is a graphical depiction of Matrix Q and FIG. 10B is a graphical depiction of Matrix R obtained from a (numerically) exact factorization of the matrix Z depicted in FIG. 9; blackened areas indicate nonzero matrix entries. See also FIG. 4 Example #2 manuscript set forth, as labeled, EXHIBIT A.

FIG. 11 A schematic illustrating rectangular coordinates of a representative target geometry, see also FIG. 1 of Example #3 manuscript set forth, as labeled, EXHIBIT B.

FIG. 12 A gray scale image of absolute value of elements of P-matrix for TM_{z} scattering from a 10l'3l PEC rectangle. A logarithm scaling is used. Black indicates matrix elements greater than 10, and white indicates matrix elements smaller than 0.01. N=312 uniformly spaced samples were used to discretize the target. N_{ƒ}=174 angles were used to sample the incident plane wave spectrum. See also FIG. 2 of Example #3 manuscript set forth, as labeled, EXHIBIT B.

FIG. 13 An illustration of a multilevel binary tree used to define spatial groups on surface of an example convex target. See also FIG. 3 (Example #3) manuscript set forth, as labeled, EXHIBIT B.

FIG. 14 Graphical representations of matrix B (top depiction) and FFT of columns of L in local coordinates (bottom depiction) for scattering from square cylinder with a=b=50l. Nonzero entries are shaded black. See also FIG. 4 of Example #3 manuscript set forth, as labeled, EXHIBIT B.

FIG. 15 Graphically depicts a total number of nonzero entries (nnz) in P-matrix (tiny squares) and in BTM representation of P-matrix (tiny circles) as function of N for a square cylinder (empty symbols) and a rectangular cylinder for which b=10 (solid symbols). The dashed-dotted line is the equation nnz=0.4 N². The dashed line is nnz=2 N^{1.5}. See also reference made to FIG. 6 of Example #3 manuscript set forth, as labeled, EXHIBIT B.

FIG. 16 A depiction of the general structure of transformed PWT operator, ΛD₀. Solid black colored sections indicate nonzero matrix entries. Four small blocks are the result of electrical current modes which radiate to one of four angular regions. Wider blocks correspond to current modes which radiate to larger angular regions.

FIG. 17 The properties of the BCM are illustrated for TM_{z} scattering from an open, perfectly conducting cylinder (cross-sectional view) with radius a and interior angle b. When b=2p, the open problem reduces to the problem of scattering from a closed circular cylinder.

FIG. 18 A depiction of a beam footprint matrix, B, for plane wave scattering from the PEC shell of FIG. 17 when a=20l and b=2p . N=1200 points are used to discretize the target, and N=558 angular samples are used in forming P. The nonzero elements of the B matrix which are retained for a requested tolerance of e=0.01 are shown as blackened areas. The zero elements of B are white.

### DETAILED DESCRIPTION OF EMBODIMENTS DEPICTED IN THE DRAWINGS

By viewing the figures—depicting representative functional components of a variety of embodiments of the new technique—along with any additional technical materials identified herein as EXAMPLES 1, 1.2, 1.3, 1.4, and 1.5 as well as associated manuscripts authored by the applicant (EXHIBITS A, B, and C), one can further appreciate the unique nature of core as well as additional and alternative features of the new technique/method and associated program code. Occasional reference is made back-and-forth to the figures and within respective EXAMPLES so as to better appreciate the features of the new technique/method, its components/subcomponents, and associated program code of the invention depicted throughout-as well as to incorporate examples showcasing implementation of the novel framework.

U.S. provisional patent application No. 60/797,011 was filed 02 May 2006 for the applicant on behalf of the assignee hereof: the specification and associated drawings of this provisional application—authored by the applicant hereof—are incorporated herein by reference, substantially in entirety, providing ample background technical support to the extent consistent herewith.

I. Useful Definitions of Terms used Herethroughout.

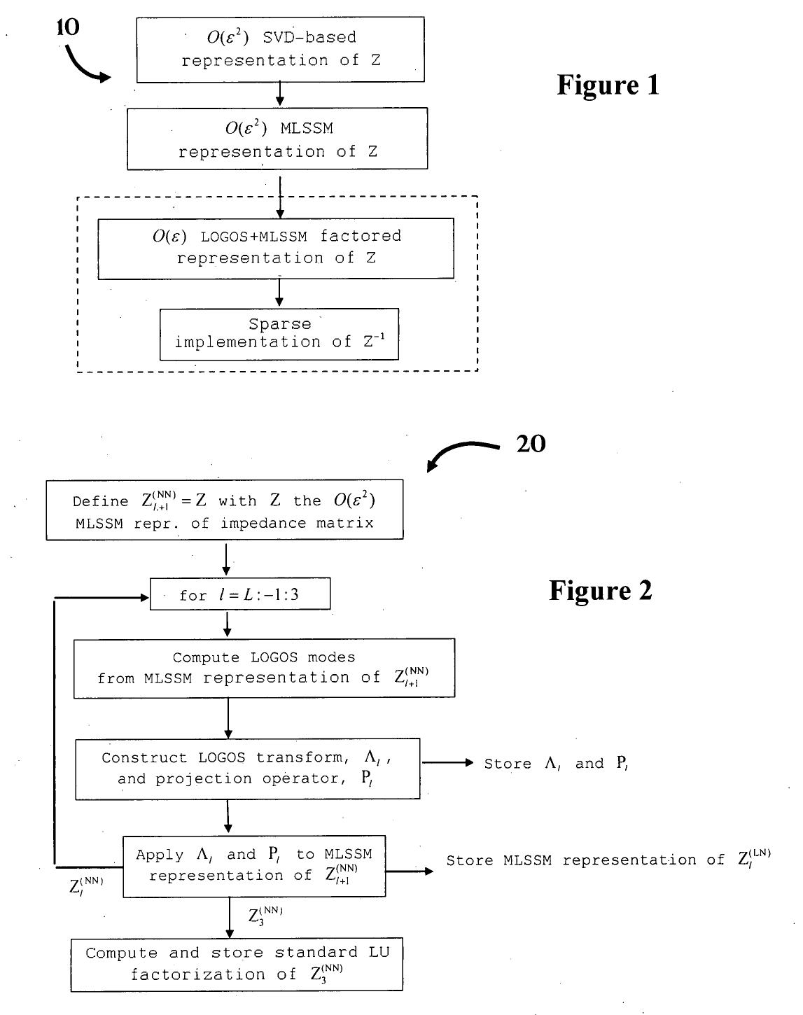

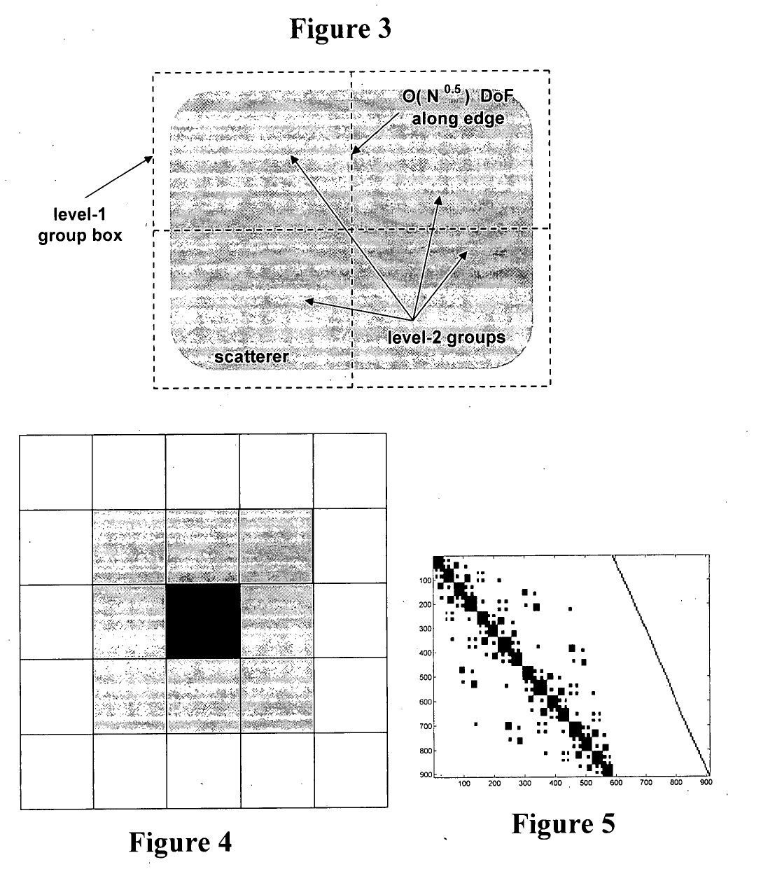

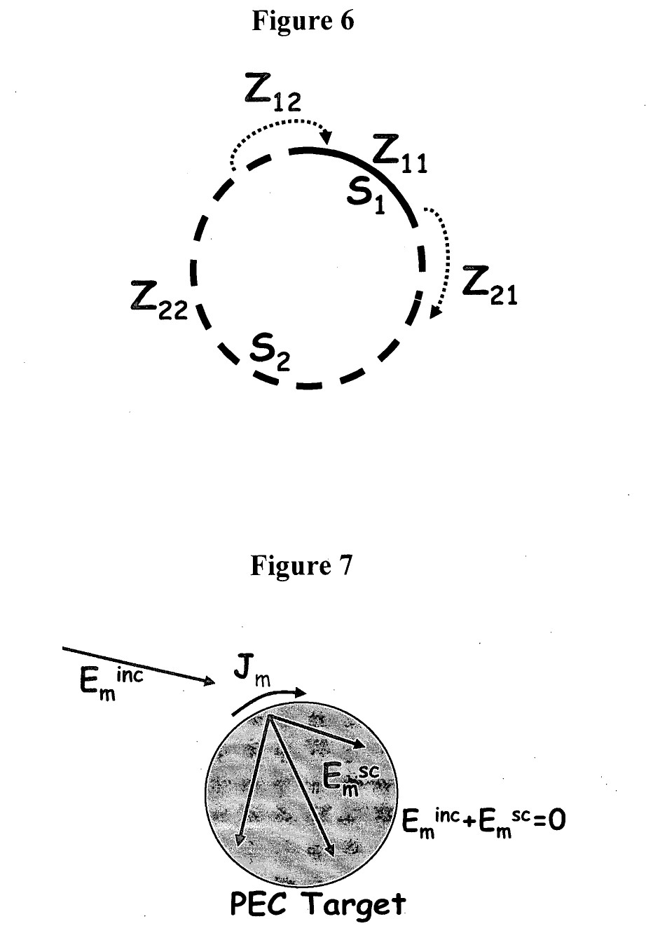

System: The underlying matrix equation (or linear system) that is being solved. An example is the matrix equation Z J=Eⁱ. In this linear system, the M-by-N matrix Z is referred to as the system matrix. The system matrix may be either sparse, full, or a hybrid of sparse and full matrices.
   A sparse system matrix results when one obtains the linear system by discretizing a PDE formulation of Maxwell's equations using, for example, a finite element method.
   A full system matrix results when one obtains the linear system by discretizing an integral equation formulation of Maxwell's equations. Discretization methods include the Method of Moments, see A. F. Peterson, S. L. Ray, and R. Mittra, Computational Methods for Electromagnetics. New York: IEEE Press, 1998, and Nyström methods, see S. D. Gedney, “On Deriving a Locally Corrected Nyström Scheme from a Quadrature Sampled Moment Method,” IEEE Transactions on Antennas and Propagation, vol. 51, pp. 2402-2412, 2003.
   Hybrid system matrices result from the use of PDE formulations of Maxwell's equations in one region of a simulation domain and an integral equation formulation of Maxwell's equations, in another region of a simulation domain. A hybrid system matrix is composed of blocks, one or more of which matrix blocks are sparse, and one or more of which matrix blocks are full.
Compressed representation of a matrix: Let Z be an M-by-N matrix. The number of numbers in the matrix Z is equal to M*N. A compressed representation of a matrix Z is a representation requiring significantly fewer than M*N numbers to recover/represent the entire Z matrix within a certain level of accuracy.
Sparse matrix: Let A be an M-by-N matrix. The matrix A is said to be sparse if it contains significantly fewer than M*N nonzero numbers.
Iterative solution methods: An iterative solution method (or solver) attempts to solve a system of equations (a matrix equation) by starting with an initial solution guess/estimate and then finding a sequence of successive approximations to the solution. For an arbitrary excitation (or forcing vector) of a general linear system, the number of computational operations required for an iterative solution procedure to converge to a specified level of accuracy cannot be predicted a priori.
Direct solution methods: The novel direct solution methods contemplated herein for the linear matrix equation, Z J=Eⁱ represent the solution, J, as a product of matrices multiplying (or ‘operating on’) the forcing vector, Eⁱ. Direct solution methods satisfy the following property. The desired solution vector(s)/mode(s), J, can be obtained from Eⁱ as a finite product of matrices—i.e., ‘solution operators’ (A₁ A₂ . . . Aₙ)—that multiply Eⁱ, viz.,
   J=(A₁A₂ . . . Aₙ)Eⁱ
The matrices, Aᵢ, are derived from information in the matrix Z (and possibly also additional, supplementing information). Distinguishable from the unique direct solution techniques contemplated herein, are traditional direct solution methods, including:
   An LU factorization is obtained by first computing the factorization Z=LU where L and U are lower and upper triangular matrices, respectively. In this case, the desired solution is obtained with n=2, and Aᵢ=U⁻¹ and A₂=L⁻¹. The operations indicated by L⁻¹ and U⁻¹ are typically implemented via forward and backward substitution procedures, though one might also explicitly form the indicated inverse matrices, see below.
   A second, direct representation is obtained by explicitly forming L⁻¹ and U⁻¹ and multiplying the resulting matrices together. In this case, n=1 and A₁=(U⁻¹L⁻¹).
   Unlike iterative solution methods, the number of operations required by a direct solution procedure can often be determined a priori for an arbitrary excitation vector.
Solution modes: A solution mode is defined as a solution of a governing system equation (e.g., Z J=Eⁱ) that also satisfies one or more auxiliary constraints. These auxiliary constraints may or may not be related to or derived from the system equation. In most cases, the auxiliary constraints will be represented by one or more additional linear systems, e.g., Y₁ J=F₁ⁱ, Y₂J=F₂ⁱ, etc.
Simulation Domain: The simulation domain is comprised of the spatial region(s) over which the elements of the system equation, Z J=Eⁱ, are defined (those elements being the system matrix, Z, the solution vector, J, and the forcing/excitation vector Eⁱ).
   Consider the problem of electromagnetic fields scattering from a conducting sphere. The simulation domain in this case might be comprised of:
      1. the surface of the sphere only, or
      2. both the surface of the sphere and the interior of the sphere, or
      3. the surface of the sphere, the interior of the sphere, and a region of space on the exterior of the sphere.
Sub-domain of the simulation domain: A subdomain of the simulation domain is a region of space (a line, a surface or a volume) that is contained by the simulation domain. In many cases, the subdomain will be a relatively small part of the total simulation domain.
Localized solutions: A solution, J, to the system equation, Z J=Eⁱ, is also a localized solution if it is non-zero only within a small number (possibly just one) of sub-domains of the simulation domain.
Sources: The desired solution vector, J, of the system matrix equation, Z J=Eⁱ, will be comprised of a combination of one or more of the following: current densities, charge densities, field fluxes, and field intensities. In all cases, the vector J is considered to be a source which radiates a type of field disturbance. The nature and magnitude of this disturbance is defined and quantified by the system matrix Z.
Radiation: The term radiate is used to describe the disturbances radiated by the source, vector J. These radiated disturbances are defined and quantified by the system matrix, Z.
Accuracy: The symbol F is used to indicate the accuracy with which a solution (or solution mode) satisfies a given matrix equation and/or set of auxiliary constraints.
Plane waves: A plane wave is a constant-frequency wave with wavefronts (i.e., the surfaces of constant phase) that are considered infinite parallel planes of constant amplitude normal to the phase velocity vector.
Plane wave spectrum: A plane wave spectrum is a complex-valued function that specifies the amplitude and phase of plane waves propagating in all possible directions. Plane wave spectra often provide a useful basis for representing electromagnetic fields.
Discrete plane wave spectrum: A discrete plane wave spectrum is a vector of complex-valued numbers that specify the amplitude: and phase of a plethora of plane waves propagating in various different directions.
Plane wave transform: A plane wave transform is the mathematical operation (an integral) that converts from a plane wave spectrum to spatial samples of the field represented by that plane wave spectrum.
Discrete plane wave transform: A discrete plane wave transform (DPWT) is the matrix, D, that results from discretizing the continuously valued plane wave transform. The DPWT is used to convert a discrete plane wave spectrum into spatial samples of the field that is represented by the discrete plane wave spectrum. In general, the DPWT is not invertible.
Pseudo-inverse: For an M-by-N matrix, D, the pseudo-inverse, represented, D⁺, is a generalized inverse of D. Unlike the standard matrix inverse, the pseudo-inverse can be meaningfully applied to non-invertible and very poorly condition matrices. The pseudo-inverse inverse can be computed a number of ways. Two well-known approaches include the Moore-Penrose pseudo-inverse procedure, and a procedure based on the singular value decomposition. In some sense, the pseudo-inverse provides a “best fit” solution to a system of linear equations.
Pseudo-inverse of the discrete plane wave transform (IDPWT): The pseudo-inverse of the discrete plane wave transform, DPWT, (collectively, IDPWT), represented as D⁺, is a matrix operator which acts oh (or multiplies) vectors that contain spatial samples of electromagnetic fields and/or currents distributed over all or part of a simulation domain. Let the vector containing the field and/or current samples be denoted Eⁱ. The plane wave spectrum, fⁱ, obtained by the following action of the IDPWT,
   fⁱ=D⁺Eⁱ,
   can be used to approximately reproduces the field Eⁱ as:
   Eⁱ≈D fⁱ.
   II. Effectively non-radiating LOGOS Direct Solution Case. (systems exposed to relatively ‘low frequency’ scattering; uses non-radiating LOGOS modes; see details in Example 1.4, additional discussion set forth in EXHIBIT C)
   Context
   Consider the following linear system derived from either a partial differential equation or integral equation based formulation of Maxwell's equations:
   Z J=−Eⁱ. Expression (1)
   In this equation, Z is referred to as the system (or impedance) matrix, J is the desired solution vector, and −Eⁱ (or simply represented as Eⁱ) is a (known) forcing vector (or plurality of vectors). For PDE-based formulations, the matrix Z is sparse. For integral equation-based formulations, Z is full. The vector (or vectors) J provides an approximate representation of the fields/currents that appear in the original PDE/integral equation. The numbers in J are hereinafter referred to as the degrees of freedom (DOFs) in the problem.
   Preliminary Steps (see FIG. 1)
   Before getting to the LOGOS factorization (i.e., solution) procedure, perform the following setup operations:
Build a multilevel decomposition of the .underlying problem geometry/simulation-domain. One example of such a multilevel decomposition is the hierarchical oct-tree. The oct-tree decomposition is hierarchical; non-hierarchical decompositions might also be used.
Build a sparse multilevel representation of the underlying system matrix, Z. This is straightforward for. PDE-based formulations. Several non-trivial but well-known sparse multilevel representations exist for integral-equation based formulations.
   Factorization Procedure (see FIG. 2)
   The following steps outline the LOGOS solution procedure based on use of generally ‘non-radiating’ LOGOS modes. This solution procedure assumes as input (i) a multilevel, decomposition of the underlying geometry and (ii) an associated multilevel decomposition of the system matrix.
Step 1. Using the sparse representation of the system matrix, and at a given level of the multilevel tree (say, level=k), compute localizing (or “non-radiating”) LOGOS modes associated with a group (the “source group”) at the present level that localizes the scattered (or radiated) fields to a small number of groups (the “observer groups”) in the vicinity of the source group. Note that within Example 1.4 and EXHIBIT C regarding designation of a given, present level: The subscript I is used, rather than k.
   1.1. In general, the source and observer groups may span differently sized regions in the vicinity of the source group. In this case, the LOGOS modes are referred to as “overlapping”; see FIG. 4, which depicts a grid of rectangles representing the concept of overlapped LOGOS modes (see, also, FIG. 3 of Example 1.4 and in EXHIBIT C, and discussion).
   1.2. The procedure used to compute the overlapped, localizing LOGOS modes from the sparse representation of the system matrix is summarized on the next two pages using pseudo code, also shown as two sets of code identified respectively as FIGS. 5 and 6 of EXHIBIT C. The technique embodied by the pseudo code described over the next two pages efficiently computes the overlapped modes.
1) Initialize \tilde{Z}_{{i(L),n}}^{(f)} to an empty matrix.
2) Loop over all levels, proceeding from coarse to fine: for l=3:L
a) Initialize A_{l,i(L)} to an empty matrix.
b) Loop over all level-l observer groups, j(l), which are both not near-neighbors of the level-l parents of {i(L),n}, and which have not been previously included at a coarser level.
i) For each such group, extract the matrix A_{j(l),i(L)} of expression (22) from the MLSSM representation of Z and append to existing A_{l,j(L)}:

$${A}_{l , i ( L )} = [ \begin{matrix}{A}_{l , i ( L )} \\ {A}_{j ( l ) , i ( L )}\end{matrix} ]$$
End loop over far-field observer groups.
c) Use SVD to compress A_{l,j(L)} matrix, maintaining a O(ε²) representation.
d) Append compressed A_{l,i(L)} to \tilde{Z}_{{i(L),n}}^{(f)}:

$${\tilde{Z}}_{\{ i ( L ) , n \}}^{( f )} = [ \begin{matrix}{\tilde{Z}}_{\{ i ( L ) , n \}}^{( f )} \\ {A}_{l , i ( L )}\end{matrix} ]$$
End loop over coarse levels (l)
3) Use SVD to compress \tilde{Z}_{{i(L),n}}^{(f)}, maintaining O(ε²) accuracy.
The above pseudo-code (numbered expressions are explained further as part of Example 1.4 and EXHIBIT C) depicts the technique for computing the submatrix \tilde{Z}_{{i(L),n}}^{(f)} of expression (20), reproduced below and as labeled in Example 1.4 and EXHIBIT C, for a given level-L source group, i(L). The notation {i(L),n} is used to denote the set of level-L groups which are near-neighbors of group i(L). This set includes the self-group, i(L).
As further explained in Example 1.4 and. EXHIBIT C: Reduced submatrix, Z_{{i(L),n}}^{(r)}, can be used instead of the original submatrix Z_{{i(L),n}} where

$$\begin{matrix}{Z}_{\{ i ( L ) , n \}}^{( r )} = [ \begin{matrix}{Z}_{\{ i ( L ) , n \}}^{( n )} \\ {{s}^{( f )} ( {v}^{( f )} )}^{H}\end{matrix} ] = [ \begin{matrix}{Z}_{\{ i ( L ) , n \}}^{( n )} \\ {\tilde{Z}}_{\{ i ( L ) , n \}}^{( f )}\end{matrix} ] , \\ and & expression ( 20 ) \\ {\tilde{Z}}_{\{ i ( L ) , n \}}^{( f )} = {{s}^{( f )} ( {v}^{( f )} )}^{H} . & Expression ( 21 )\end{matrix}$$
1) Initialization:
   a) Initialize \tilde{Z}_{{i(L),n}}^{(f)} to an empty matrix
   b) Compute T_{P(l,i(L)),I(L)} for 3≦l≦L.
2) Loop over all levels, proceeding from coarse to fine: for l=3:L
a) If X_{l,P(l,i(L))} has not yet been computed:
i) Initialize X_{l,P(l,i(L))} to an empty matrix.
ii) Loop over all level-l observer groups, j(l), which are both not near-neighbors of the level-l parents of {i(L),n}, and which have not been previously included at a coarser level.
(1) For each such group, extract the matrix X_{j(l),P(l,i(L))} of expression (27) from the MLSSM representation of Z and append to existing X_{l,P(l,i(L))}:

$${X}_{l , P ( l , i ( L ) )} = [ \begin{matrix}{X}_{l , P ( l , i ( L ) )} \\ {X}_{j ( l ) , P ( l , i ( L ) )}\end{matrix} ]$$
End loop over far-field observer groups.
iii) Use SVD to compress X_{l,P(l,i(L))} matrix, maintaining O(ε²) representation.
iv) Store compressed X_{l,P(l,i(L))} for re-use.
b) Append compressed A_{l,i(L)} to \tilde{Z}_{{i(L),n}}^{(f)} using expression (26):

$${\tilde{Z}}_{\{ i ( L ) , n \}}^{( f )} = [ \begin{matrix}{\tilde{Z}}_{\{ i ( L ) , n \}}^{( f )} \\ {X}_{l , P ( l , i ( L ) )} {T}_{P ( l , i ( L ) ) , i ( L )}\end{matrix} ]$$
End loop over coarse levels (l)
3) Use SVD to compress \tilde{Z}_{{i(L),n}}^{(f)}, maintaining O(ε²) accuracy.

As further explained in Example 1.4 and EXHIBIT C: In an alternate, preferred way to determine the \tilde{Z}_{{i(L),n}}^{(f)} matrices from the MLSSM representation of Z, it is useful to represent A_{j(l),i(L)} of expression (22) (Example 1.4 and EXHIBIT C) as the product of two matrices,
A_{j(l),i(L)}=X_{j(l),P(l,i(L))}T_{P(l,i(L)),i(L)}, Expression (26)
where
X_{j(l),P(l,i(L))}=Iⱼ₍ₗ₎Uₗ^{H}Zₗ₋₁VₗI_{P(l,i(L))}, Expression (27)
T_{P(l,i(L)),i(L)}=I_{P(l,i(L))}TₗI_{{i(L),n}}, Expression (28)
1.3. Denote the collection of localizing LOGOS modes at the present level as Λₖ^{(L)} For the case of overlapping-modes, this matrix is pictured in the left portion of FIG. 5, referred to as FIG. 4 in Example 1.4 and EXHIBIT C.
Step 2. Using the sparse representation of the system, and at the same level of the multilevel tree used in Step 1, compute a set of non-localizing modes.
   2.1. The nonlocalizing modes are computed such that:
      2.1.1. The total number of LOGOS modes (localizing plus non-localizing) associated with a given group of the multilevel tree is equal to the number of DOFs contained by that group.
      2.1.2. The composite (localizing plus nonlocalizing pieces) transform of the DOFs in the source group is invertible.
   2.2. Denote the collection of non-localizing LOGOS modes at the present level as Aₖ^{(N)}. For the case of overlapping modes, this matrix is pictured on the right portion of FIG. 5, referred to as FIG. 4 in Example 1.4 and EXHIBIT C. Note that the transformation blocks associated with the non-localizing modes do not overlap with one another.
Step 3. Let Aₖ, or Λₗ as used throughout Example 1.4 and EXHIBIT C, denote the collection of all LOGOS modes computed in Steps 1 and 2 above.
   Λₖ=[Λₖ^{(L)},Λₖ^{(N)}]
This matrix is illustrated in FIG. 5, referred to as FIG. 4 of Example 1.4 and EXHIBIT C for the case of overlapped localizing LOGOS modes. As mentioned above regarding use of a subscript designating a present level, l replaces k.
Step 4. Use the localized blocks of the product Zₖ₊₁^{(NN)} Λₖ^{(L)} to define orthonormal projection matrices Pₖ^{(L)}and Pₖ^{(N)}. These matrices are defined such that the augmented, square matrix
   Pₖ=[Pₖ^{(L)},Pₖ^{(N)}]
is unitary.
Step 5. Simultaneously multiply (or project) the system matrix using Λand Pₖ. Due to the manner in which these matrices have been defined above, this yields the following, upper-triangular, 2-by-2 block system (see Example 1.4 and EXHIBIT C, equation/expression (7) for a level-l; replacing the designator k, impedance matrix):

$${P}_{k} {Z}_{k + 1}^{( NN )} {Λ}_{k} = {[ {P}_{k}^{( L )} {P}_{k}^{( N )} ]}^{H} {Z}_{k + 1}^{( NN )} [ {Λ}_{k}^{( L )} {Λ}_{k}^{( N )} ] = [ \begin{matrix}I & {Z}_{k}^{( LN )} \\ 0 & {Z}_{k}^{( NN )}\end{matrix} ] + O ( ⅇ )$$
The key aspects of this system are:
5.1. The projected system is upper triangular (within small approximation error, O(e).
   5.2. The projected matrices Zₖ^{(LN)} and Zₖ^{(NN)} are stored in the same sparse, multilevel format that was initially used to store Zₖ₊₁^{(NN)}, with the important exception that the multilevel data structure now has one less level. (see Example 1.4 and EXHIBIT C, Section 6.2 for background analysis/justification)
   5.2.1. This property is essential to rendering the factorization procedure (Steps 1-5) recursively applicable at sequentially coarser levels of the multilevel tree.
Step 6. If k is sufficiently large (e.g., k>2 or k>3):
   6.1. Repeat steps 1-5 at the next coarser level of the tree (i.e., decrement k by one: k→k−1). See up-going arrow in FIG. 2, referred to as FIG. 7 of Example 1.4 and EXHIBIT C.

Otherwise:
6.2. Perform standard LU factorization of Zₖ^{(NN)}. (See last block of flow chart in FIG. 2, referred to as FIG. 7 of Example 1.4 and EXHIBIT C)
   Solution Procedure (see Section 8 of Example 1.4 and EXHIBIT C)

Upon completion of the sparse, direct LOGOS factorization procedure outlined above, solutions to the original system equation can be obtained using the algorithm described in Section 8 of Example 1.4 and EXHIBIT C. This solution procedure is also indicated by the last block in FIG. 1, referred to as FIG. 1 of Example 1.4 and EXHIBIT C.

III. Effectively Radiating LOGOS Modes for Sparse Direct Representations

high frequency case; uses radiating LOGOS modes; see also Example 1.3 and EXHIBIT B and Example 1.4 and EXHIBIT C)

Context

Consider the following linear system derived from either a partial differential equation or integral equation based formulation of Maxwell's equations:
Z J=−Eⁱ Expression (1)

In this equation, Z is referred to as the system (or impedance) matrix, J is the desired solution vector, and −Eⁱ is a (known) forcing vector (or vectors). For PDE-based formulations, the matrix Z is sparse. For integral equation-based formulations, Z is full. The vector (or vectors) J provides an approximate representation of the fields/currents that appear in the original PDE/integral equation. The numbers in J are hereinafter referred to as the degrees of freedom (DOFs) in the problem.

In many problems of practical interest, the forcing vector −Eⁱ (or incident field) can be accurately expressed using a spectrum of plane waves:

$$\begin{matrix}- {E}^{i} = \frac{1}{2 p} {{Ò}_{2 p}}^{{ⅇ}^{jk \times ρ}} {f}^{i} ( f ) df \\ = {Df}^{ i}\end{matrix} \qquad expression ( 2 )$$

In this equation, vector fⁱ is the incident spectrum of plane waves, and D is a discrete representation of the plane wave transform integral appearing in the first line of (2).

Using (2) in (1), the desired solution vector J is given by

$$\begin{matrix}J = {Z}^{- 1} {Df}^{ i} \\ = {Pf}^{ i}\end{matrix} . \qquad expression ( 3 )$$

In this equation, the matrix P is defined as P=Z⁻¹D. The matrix P is hereinafter referred to as the plane-wave response matrix (P-matrix).

The next section “Preliminary Steps” describes procedures to (i) find a sparse (or compressed) representation for P using radiating LOGOS modes, and (ii) combine the sparse representation of P with a sparse pseudo-inverse of the plane wave transform D to obtain a sparse (or compressed) representation of the inverse of Z (i.e., Z⁻¹).

Preliminary Steps (see for further reference, Example 1.3 and EXHIBIT B)

Before getting to the procedures for compressing P and Z⁻¹, perform the following setup operations:
Build a multilevel decomposition of the underlying problem geometry/simulation-domain. Examples of such multilevel decompositions include the hierarchical binary-tree, quad-tree, and oct-tree decompositions.
Build a multilevel decomposition of the plane wave directions used to define the plane wave transform D. Examples of such multilevel decompositions include the hierarchical binary-tree, quad-tree, and oct-tree decompositions.
Build a sparse multilevel representation of the underlying system matrix, Z. This is straightforward for PDE-based formulations. Several non-trivial but well-known sparse multilevel representations exist for integral-equation based formulations.
   Procedure for Determining a Compressed Representation of the P-matrix (Example 1.3 and EXHIBIT B)

The following steps outline the radiating LOGOS mode-based procedure for compressing the plane wave response matrix, P. This solution procedure assumes as input (i) a multilevel decomposition of the underlying geometry, (ii) a multilevel decomposition of the angular directions used to define the plane wave transform D, and (iii) an associated multilevel decomposition of the system matrix.

Step 1 Begin a loop over the levels in the multilevel tree. Let k indicate the loop variable, and proceed from the finest level to the coarsest level.

Step 2 If the level (k) is the finest level of the multilevel tree, then, for each group at level-k (the “source group”), form the constraint matrix X (this is equation/expression (33) of Example 1.3 and EXHIBIT B):

$$\hat{X} = [ \begin{matrix}{C}_{α , 21} {C}_{α , 11}^{- 1} {\hat{D}}_{α , 1} - {\hat{D}}_{α , 2} \\ {\hat{D}}_{α , 1}\end{matrix} ]$$

Otherwise, if we are at a coarser level of the multilevel tree, then also orthogonalize the constraint equation to the plane wave modes previously determined at a sparser level of the multilevel tree:

$$\hat{X} = [ \begin{matrix}{C}_{α , 21} {C}_{α , 11}^{- 1} {\hat{D}}_{α , 1} - {\hat{D}}_{α , 2} \\ {\hat{D}}_{α , 1}\end{matrix} ] Φ$$

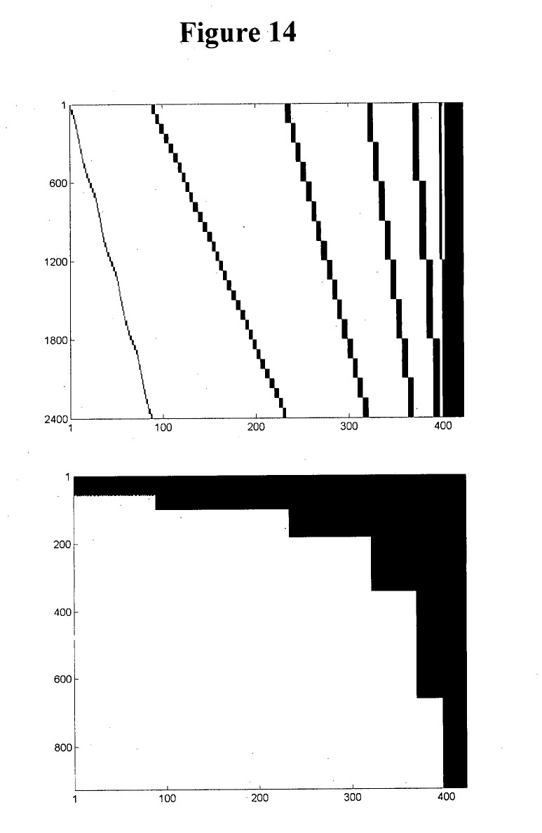

In this last equation, the matrix Φ is a projection matrix which orthogonalizes the domain of \hat{X} to all previously computed radiating LOGOS modes that were localized to a finer level of the multilevel tree. The matrix Φ is computed using radiating LOGOS modes determined at finer levels of the multilevel tree.
2.1 The matrices C_{α21} and C_{α21} used to define the constraint matrix, \hat{X}, are derived from the system matrix Z and/or a related linear system. For a given level-k source group, the matrix \hat{D}_{α,1} is a filtered portion of the full plane wave transform matrix D associated with that source group. The matrix \hat{D}_{α,2} is a filtered portion of the full plane wave transform matrix D associated with all level-k groups except the source group.
   Step 3 From the constraint matrix, \hat{X}, for each level-k group, compute the radiating LOGOS modes that, to order-ε, are localized to that group. Let the matrix Λₖ denote the collection of all radiating LOGOS modes determined at level-k from the constraint matrix \hat{X}.
3.1 The columns of Λₖ are the (bandlimited) plane wave spectra that generate combinations of the original DOFs that are localized to specific level-k groups. Let the matrix B indicate the collection of these localized combinations of the original DOFs at all levels. (Matrix B is illustrated in FIG. 14 hereof, referred to as FIG. 4 of Example 1.3 and EXHIBIT B.)
3.2 In some cases we will want to allow the radiating LOGOS modes to be localized to a small number of level-k groups (not just the source group).
Step 4 Decrement k by one and repeat Steps 1-3 until the level k=1 (i.e., the coarsest, or root, level) of the multilevel tree is reached, at which point continue to Step 5.
   Step 5 At this point, a sparse representation of the plane wave response matrix (P) has been determined, which is accurate to order-ε. This sparse representation is given by:
   P=BΛ^{H}+O(ε) Expression (4)

As indicated above, B is the matrix of localized DOFs, and Λ^{H} indicates the Hermitian conjugate of Λ. The matrices B and Λ^{H} are illustrated in FIG. 14 hereof, referred to as FIG. 4 of Example 1.3 and EXHIBIT B for a specific example.
5.1 This sparse representation of P provides a sparse, direct (i.e., non-iterative) solution for the problem of scattering from electrically large obstacles.
5.2 For a given plane wave spectral excitation, fⁱ, the procedure used to compute the solution vector, J, using the sparse representation of P given in equation/expression (4) immediately above is explained at the end of Section E of EXHIBIT B.
   Procedure for Compressing the Inverse of the Impedance Matrix (see Example 1.5 and EXHIBIT D)

The following steps outline the radiating LOGOS mode-based procedure for determining a compressed representation of the inverse of the impedance matrix, Z⁻¹. This solution procedure assumes as input (i) a multilevel decomposition of the underlying geometry, (ii) a multilevel decomposition of the angular directions used to define the plane wave transform D, and (iii) an associated compressed representation of the plane wave response matrix, P (see above for procedure to compress P).
Step 1. Determine a compressed representation of the plane wave response matrix, P.
Step 2. Determine a compressed representation of the plane wave transform matrix, D, by using spatially localized field distributions that generate plane wave distributions which are simultaneously localized in angle space and bandlimited.
Step 3. Determine a sparse QR factorization of sparse plane wave transform.

### EXAMPLE 1

### An Implementation

Expressions/equations are numbered consecutively within EXAMPLE 1 independently from those above, and independently from the subsequent EXAMPLES 1.2, 1.3,1.4, and 1.5. Numerical simulations of linear time-harmonic electromagnetic phenomena are reduced to the solution of linear systems having the form
ZJ=Eⁱ, (1)
where Z is an N-by-N matrix, J is an N-by-1 vector of unknown coefficients, and Eⁱ is a forcing vector. Equation (1) is usually obtained from Maxwell's equations using either integral equations (IEs), partial differential equations (PDEs), or a combination of these two representations. The representation used determines certain general properties of Z and thereby impacts the practical details of the solution strategy used to determine J for a given excitation. Of course, the underlying physical phenomena are independent of the chosen representation.

Throughout this Example 1, it will be assumed that (1) is determined using surface and/or volume integral equations. It is therefore important to emphasize that, because the following LOGOS algorithms are based on the physical properties of electromagnetic fields, the direct solution strategies discussed below can be applied to both PDE and IE representations of electromagnetic phenomena.

Relation to Existing CEM Technologies

An essential characteristic of IE-based representations is that Z (the impedance matrix) is a full N-by-N matrix, where N is the number of degrees-of-freedom (DoF) in the problem solution. This property, coupled with the prohibitive computational costs of standard direct solvers and a dearth of effective sparse direct solvers for CEM, has motivated more than twenty years of continuing efforts to develop fast iterative solution methods for CEM applications.

State-of-the-art, conventional iterative CEM algorithms have certain features which limit their effectiveness and/or applicability in a number of practical applications.
Multiple right hand sides. The computational costs associated with iterative algorithms are particularly significant when solutions are desired for multiple, linearly independent excitations.
High latency. Consider an application for which an engineer would like to incorporate a CEM model as part of a feedback/control loop. In such a system, it may be necessary to quickly determine the electromagnetic response to a new excitation. If an iterative solver is used, the user/system must wait for the solver to converge before incorporating the desired information in its adaptation to a new/changing environment. The proposed direct solution strategies can dramatically reduce the latency associated with iterative CEM models by allowing set-up calculations to be performed offline and using the resulting direct model in near-real-time.
No reduced-order models. As discussed above, iterative models prevent the efficient determination of full-wave reduced order models for complex scenes/targets/devices.
Perturbative design is not possible. In a large number of practical CEM applications, an engineer is interested in monitoring the effects of small changes made in a small region of a larger target/scene on the electromagnetic response of the entire system (e.g., designing a conformal antenna to operate on an automobile). Iterative methods provide no general, controllable mechanism to make advantageous use of the fact that geometric modifications are limited to a relatively small piece of a larger target.
   These limitations of iterative solvers can be avoided through the development of new, broadband, direct solvers for CEM applications.

To date, relatively little progress has been made in developing generally applicable fast direct solution strategies for CEM applications. Some of the pioneering work in this area was performed by Canning. While Canning's early work provided sparse direct representations for Z⁻¹ in (1) as labeled in this EXAMPLE 1, the resulting algorithms exhibit instabilities and fail to provide an optimal, O(N log^{α} N), scaling for electrically large problems. None of the early direct solution schemes provide scalable (i.e., O(N log^{α} N)) algorithms for either high or low frequency applications.

LOGOS Modes

The proposed direct solution algorithms are based on the expansion of an arbitrary electromagnetic solution operator (e.g., Z⁻¹) in numerically determined modes which simultaneously satisfy local and global boundary conditions. For convenience these modes are referred to throughout as LOGOS (local-global solution) modes.

To illustrate the numerical determination of the LOGOS modes, consider the case for which (1) corresponds to a surface IE (SIE). Let the surface on which the SIE is defined be denoted S, and let S be decomposed into two non-overlapping pieces, S=S₁+S₂ (cf. FIG. 6). For convenience, we will refer to S₁ and S₂ as “Region 1” and “Region 2,” respectively. This decomposition of S leads to an associated representation of (1):

$$[ \begin{matrix}{Z}_{11} & {Z}_{12} \\ {Z}_{21} & {Z}_{22}\end{matrix} ] [ \begin{matrix}{J}_{1 , m} \\ {J}_{2 , m}\end{matrix} ] = [ \begin{matrix}{E}_{1 , m}^{i} \\ {E}_{2 , m}^{i}\end{matrix} ] , \qquad ( 2 )$$

where J_{1,m} is that part of Jₘ associated with Region 1, J_{2,m} is associated with Region 2, Z₁₂ corresponds to interactions from Region 2 to Region 1, etc. The integer subscript “m” on Jₘ and Eₘⁱ is used to index the LOGOS modes. A single LOGOS modes is defined by an excitation/solution pairing (Eₘⁱ,Jₘ).

Consider the determination of LOGOS modes for which Jₘ is localized to Region 1 (i.e., J_{1,m}¹ 0, J_{2,m}=0). The local condition associated with these modes is
Z₁ₗJ_{1,m}=E_{1,m}ⁱ (3)
The global condition is
Z₂ₗJ_{1,m}=E_{2,m}ⁱ (4)
Combining (3) and (4) immediately above provides the single local-global condition satisfied by all LOGOS modes.

Consider the problem of determining an order-ε representation of Z⁻¹ in (1). A fundamental concept behind the LOGOS algorithms is to expand the N-by-N impedance matrix, Z, in a complete basis of N LOGOS modes, {(Jₘ,Eₘⁱ)}ₘ₌₁^{N}, determined by imposing (5) to order-e at successively coarser levels of the multilevel spatial tree which decomposes a given target.

LOGOS modes have been classified herein as either radiating or nonradiating.

Nonradiating LOGOS Modes

Nonradiating LOGOS modes are determined by imposing (to order-e) the version of (5) obtained when E_{2,m}ⁱ=0,
Z₂ₗZ₁ₗ⁻¹E_{1,m}ⁱ=0 (6)
These LOGOS modes are designated nonradiating because the field scattered from Region 1 to Region 2 is zero to order-e (i.e., Z₂ₗJ_{1,m}>>0). Because both the source (Jₘ) and the excitation (Eₘⁱ) associated with a nonradiating LOGOS mode are localized to a finite region of a larger target, both the impedance matrix and its inverse are sparse in this basis. The nonradiating LOGOS modes are sufficient to determine a fast direct solution algorithm for electromagnetic phenomena which occur at low- to moderate frequencies (i.e., the simulation domain is on the order of a few wavelengths or smaller). Efficient direct solution algorithms at higher frequencies require the additional incorporation of radiating LOGOS modes.
Radiating LOGOS Modes

Those modes satisfying (5) which do not also satisfy (6) are referred to as radiating LOGOS modes. Consider the case of scattering from a PEC target illustrated in FIG. 2. A radiating LOGOS mode is a solution/excitation pairing, (Eₘ^{inc},Jₘ), in which the solution (Jₘ) is localized to a small region of a larger target. Unlike the nonradiating LOGOS modes, the excitation (Eₘ^{inc}) and scattered field (Eₘ^{sc}=ZJₘ) are both global functions, being generally nonzero over the entire simulation domain.

Whereas the nonradiating LOGOS condition (6) leads directly to sparse forms of Z and Z⁻¹, the scattered field associated with a radiating LOGOS mode is generally nonzero over an entire target. Efficient numerical manipulation of these modes is accomplished using bandlimited functions.

Fast Direct Solutions at Low to Moderate Frequencies

The applicant has devised multilevel numerical procedure used to determine the LOGOS modes which satisfy (6) to order-e. That procedure produces a sequence of N-by-N sparse, full-rank, block diagonal transformations, Lₗ, defined at each level (l) of the multilevel tree. Using L to denote the multilevel LOGOS transform obtained as the product of the Lₗ yields the following compressed representation of Z:
Z(LL⁻)J>>\hat{Z}L⁻¹J=Eⁱ, (7)
where \hat{Z} is the LOGOS transform of the impedance matrix. The approximation indicated in (7) is a consequence of truncating those rows of the transformed impedance matrix which are outside of the group to which a given LOGOS mode is localized.
The Basic LF Algorithm

Both Q and R in the (numerically) exact QR factorization of \hat{Z}(\hat{Z}=QR) are sparse at low to moderate frequencies. It therefore follows from (7) that the order-e representation of the inverse of the impedance matrix can be implemented as
Z⁻¹>>L R⁻¹Q^{H} (8)
The direct solution strategy indicated by (8) is referred to as the “basic” nonradiating LOGOS solver.
Spectral Excitations

This limitation has been overcome using bandlimited spectral representations for the radiating LOGOS modes. Because the Jm associated with each radiating LOGOS mode are by definition localized to a finite region of a larger target (cf. FIG. 6 hereof), it can be shown that the excitation (Eₘⁱ) and scattered (ESₘ^{sc}=ZJₘ) fields have bandlimited spectral representations. This in turn allows the resulting modes to be efficiently manipulated in the spectral domain using fast interpolation and filtering operations. In particular, let P denote the spectral solution operator defined as
P=Z⁻¹D, (9)
where Z is the impedance matrix of (1), and D is the plane wave transform operator which maps a given spectral excitation (i.e., a sum of plane waves) to the associated incident fields indicated by Eⁱ in (1). The spectral solution operator P (P-matrix) provides a mapping from an incident plane wave spectrum to the currents excited in the simulation domain.

Bandlimited radiating LOGOS modes provide a compressed representation of the spectral solution operator (i.e., the P-matrix) for convex targets in two dimensions which scales as O(N^{1.5}) at high frequencies. The use of overlapping, radiating LOGOS modes provides a representation of the spectral solution operator with a complexity which scales as O(N log N) at high frequencies. Applicant's results represent the first error-controllable sparse direct representation of the solution operator at high frequencies.

Although explained herein in connection with simple convex targets, these results are contemplated for more complex targets by decomposing a given target into smaller, spatially distinct regions. The spectral solution can then be determined. An essential feature of such an algorithm in the present context is that the inverse operators required at each step of the recursion can be viewed as the interaction of a given spatial region with exterior sources/scatterers. Since additional interactions originate outside a given group they can be represented in a plane wave (i.e., spectral) basis. This in turn implies that the bandlimited LOGOS methods described above can be used to compress each spectral solution operator encountered in the recursive solution procedure.

General Excitations

The availability of a fast direct representation for the spectral solution operator (cf. (9)) leads naturally to the question of the relationship between it and the inverse of the impedance matrix. For a particular class of two-dimensional scattering problems the desired connection is provided by the pseudo-inverse of the plane wave transform. Symbolically,
Z⁻¹>>PD⁺ (10)
where D⁺ indicates the pseudo-inverse of the plane wave transform. It has been shown that this representation provides an accurate representation of the inverse of the impedance matrix for excitations located inside closed PEC cavities. This remarkable ability to use the (exterior) spectral solution matrix (P) to determine solutions excited by interior sources is explained by image theory. The pseudo inverse of the plane wave transform provides a least-squares mapping of the incident field on the surface of the target (i.e., Eⁱ in (1)) to an approximately equivalent plane wave representation of fields excited by an equivalent set of exterior image sources. The spectral solution operator (P) subsequently maps the resulting plane wave spectrum to the desired approximation of the unknown J.

The ability to find order-e representations of Z⁻¹ using (10) hinges on an ability to find order-e solutions of Eⁱ=Dfⁱ for a given Eⁱ.

Reduced-Order Models

In the absence of resonances, (1) provides an invertible set of constraints on the equivalent currents J. In practice, one might be interested in the currents, however, there is generally more interest in a quantity which can be derived from J. For example, one may only be interested in the external response of a complex scene/target to external excitations. When iterative CEM models are used, the only well-defined pathway to an error-controllable solution consists of first computing the equivalent currents and subsequently using the currents to compute the scattered fields.

The LOGOS framework provides an attractive alternative for the example just specified. Let S denote the scattering matrix derived from (9) as
S=A P=A Z⁻¹D, (11)
where A denotes the linear operator which maps from surface currents to the associated plane wave spectrum (i.e., the scattered field). The S-matrix provides a mapping from incoming plane waves to outgoing plane waves and thus characterizes the electromagnetic response of the underlying electromagnetic scattering problem. The scattering matrix (11) represents a reduced-order model of the underlying scattering problem because its dimension depends only on the number of DoF (i.e., plane wave directions) required to completely characterize a given targets response to separated observers. This in turn depends only on the cross-sectional area of the target. Thus, the electromagnetic response of a complicated target (e.g., containing significant small-scale features) can be equivalently represented using relatively fewer DoF via the scattering matrix. Furthermore, the structure of the P-matrix and the properties of the far-field transform matrix A are sufficient to guarantee a compressed representation for S through the use of bandlimited functions in both its domain and range.

Reduced-order models of the type indicated by (11) are expected to facilitate the development of error controllable reduced-order models for electrically large and complex scenes with computational complexities (memory and CPU) that are significantly less than the number of degrees of freedom (i.e., N) required to accurately represent the underlying material configuration.

### EXAMPLE 1.2, see also further details in EXHIBIT A: Example Application

Expressions/equations are numbered consecutively within EXAMPLE 2 independently from the other EXAMPLES 1, 1.3, 1.4, and 1.5, and referenced as such, below.

1 Introduction

Numerical solutions of surface integral equation formulations of time-harmonic electromagnetic interactions with perfect conductors involve solving linear systems of the form
Eⁱ=Z J, (1)
where Z is the impedance matrix, the vector J contains the coefficients of the basis functions used to represent the electric currents on the surface of an obstacle, and the vector Eⁱ is determined by samples of an impressed electric field. In general, the matrix Z is full. Consequently, the computational costs associated with standard solutions of (1) are prohibitive for problems with a large number of unknowns (N). To avoid this limitation, a number of fast solution methods have been proposed.
2 Problem Definition

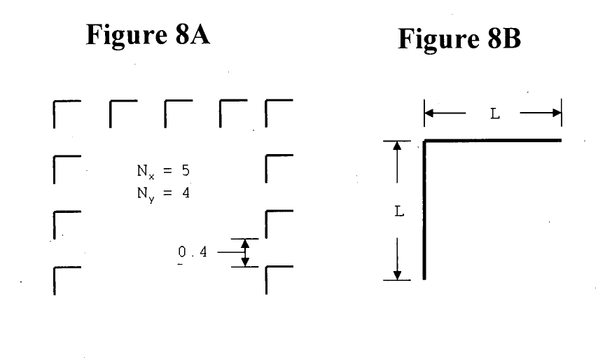

The description of the LOGOS-based sparse direct solution method provided in this EXAMPLE 1.2 is focused on boundary integral equation formulations of TM_{z} scattering from the array of open, perfectly electrically conducting (PEC) dihedral cylinders indicated in FIGS. 8A and 8B. The resulting boundary value problem is formulated using the electric field integral equation (EFIE). Herein, finite projections of the continuous integral equations are obtained using a point-matching moment method discretization with N basis and N testing functions. This reduces the TM_{z} EFIE to an N′ N matrix equation of the form,
Mⁱ=Z J (2)
The vector Mⁱ contains samples of the z-directed incident electric field on the surface of a target, and J is the vector of inknown coefficients for the z-directed surface current.
3 Spatial Groups

The LOGOS compression algorithm for Z relies on a multilevel spatial decomposition of points on the surface of a target. This is accomplished in the following examples using a multilevel quad-tree decomposition of the space in which a given target is embedded. The resulting spatial groupings are identical to those used to implement the multilevel fast multipole algorithm in two dimensions.

The number of levels in the tree is denoted by L. The individual levels are indexed by l, l=1, . . . , L. The level l=1 is the root level of the tree. The root level consists of a single group containing all spatial samples. The number of nonempty groups at the lth level of the tree is M(l), and the number of spatial samples in each group is approximately m(l)=N/M(l). The total number of levels, L, is chosen so that the smallest spatial group in each branch of the multilevel tree contains approximately ten points.

The index i(l) is used to enumerate the non-empty groups at each level. In the remainder of this paper we will denote a matrix associated with a given group, i(l), at specific level, l, using notation of the form Xᵢ₍ₗ₎. The subscript i(l) is used to indicate both the level and the group number at that level with which the matrix is associated. The level-l groups contained by a given group at level-(l−1) are referred to as the level-l children of that level-(l−1) parent. Groups at level-L have no children, and the root group has no parent.

4 Multilevel LOGOS Compression Algorithm

Let the scatterer geometry be divided into two regions based on the ith group at level-l (group i(l)). Let Region 1 consist of points on the surface of the scatterer in group i(l), and let Region 2 consist of the remaining points. Define Z₁ₗ, as that portion of the impedance matrix corresponding to interactions between sources and observers on Region 1, and let Z₂ₗ indicate the fields excited in Region 2 due to sources in Region 1. Nonradiating, spatial local-global solutions are defined as those modes Jₘ confined to Region 1 which satisfy the over-determined system

$$[ \begin{matrix} {Z}_{ 11} \\ {Z}_{ 21}\end{matrix} ] {J}_{m} = [ \begin{matrix}{E}_{m}^{i} \\ 0\end{matrix} ] , \qquad ( 3 )$$

where the excitation Eₘⁱ is zero at observation points located in Region 2.

Equation (3) imposes two simultaneous conditions. First, the Jₘ satisfy the local boundary condition, Zₗ₁ Jₘ=E^{m}ⁱ. Satisfaction of the global boundary condition is imposed by requiring that the radiation of these modes from Region 1 to Region 2 be zero: Z₂ₗJₘ=0. In the following, the current/source pairing (Jₘ,Eₘⁱ) obtained from (3) is referred to as a nonradiating LOGOS mode.

The multilevel numerical procedure used to determine the LOGOS modes which satisfy (3) to order-e yields a sequence of N′ N sparse, full-rank, block diagonal transformations, Lᵢ, defined at each level of the multilevel tree (l=1, . . . , L). These are used to compress Z as
Z=Z(L₁ . . . L_{L})(L_{L}⁻¹ . . . L₁⁻¹)>>\hat{Z}(L_{L}⁻¹ . . . L₁⁻¹) (4)
where each of the Lₗ is considered invertible. The approximation obtained in passing from the first to the second line of (4) is a consequence of truncating those rows of the transformed impedance matrix, \hat{Z}, which are outside of the group to which a given LOGOS mode is localized.

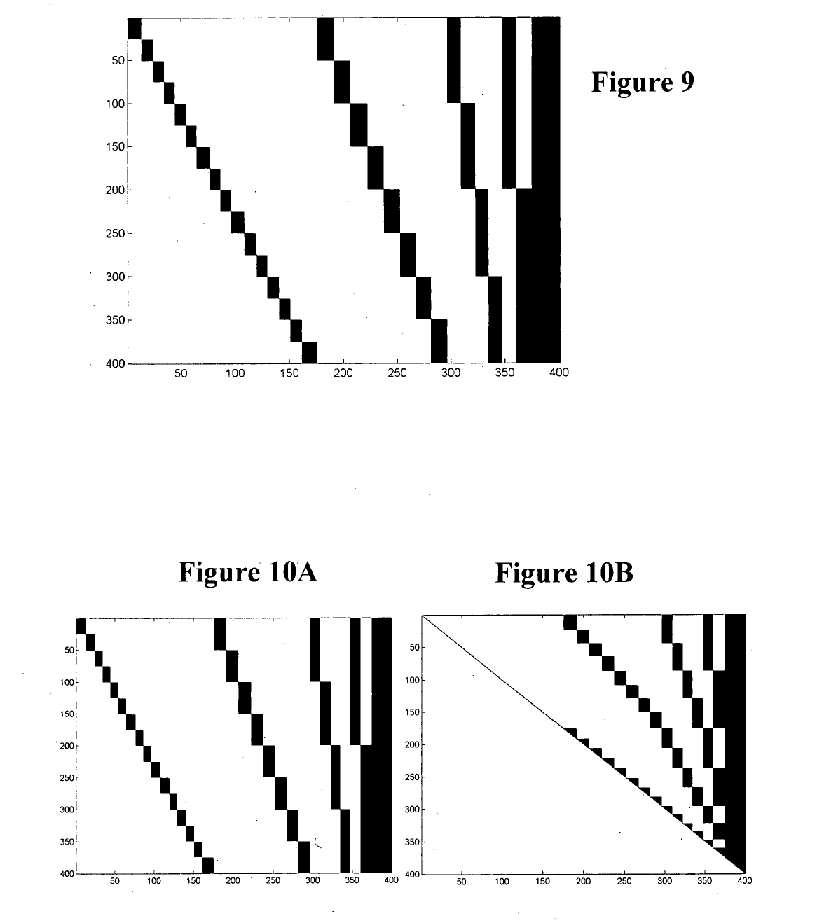

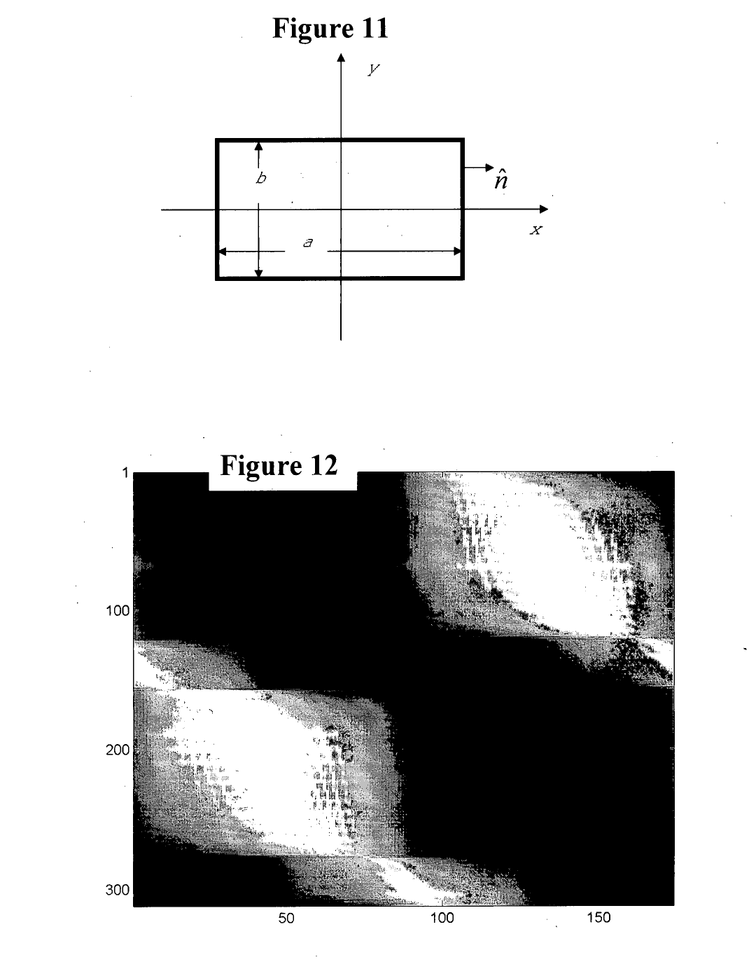

FIG. 9 hereof (labeled FIG. 2 in EXHIBIT A) illustrates the sparsity pattern of \hat{Z} in the LOGOS basis for the target depicted in FIGS. 8A and 8B when L=0.1l, Nₓ=8, N_{y}=17. An input tolerance of e=0.001 is used. The actual MRS difference between the full impedance matrix and the sparse LOGOS representation is 1.92′10⁻⁴. (The structure of \hat{Z} indicated by FIG. 9 hereof, FIG. 2 in EXHIBIT A, was obtained by permuting the block diagonal transformation matrices, Lₗ.)

5 Direct Solution in LOGOS Basis

FIGS. 10A and 10B9 hereof (labeled FIG. 4 in EXHIBIT A) depict the structure of the (numerically) exact QR factorization of the LOGOS transformed impedance matrix considered in FIG. 9. The sparsity pattern of the unitary matrix Q is identical to the sparsity pattern of \hat{Z}. The upper triangular matrix R is similarly sparse. The sparsity of the QR factorization is a direct consequence of the sparsity pattern induced by the truncated LOGOS transform of the impedance matrix.

The sparsity of Q and R immediately suggests an efficient implementation of the inverse of the original impedance matrix:
Z⁻¹>>(L_{L}⁻¹ . . . L₁⁻¹)⁻¹\hat{Z}⁻¹=(L₁ . . . L_{L})R⁻¹Q^{H}, (5)
where
\hat{Z}⁻¹=(QR)⁻¹=R⁻¹Q^{H} (6)
Because the L₁⁻¹ are stored as block diagonal matrices, the inverses of these operators required in (5) can be rapidly calculated. However, if one is interested in determining a sparse representation of Z⁻¹ (and not a sparse representation of Z), then it is not necessary, to actually compute the Lₗ⁻¹; the Lₗ required in (5) are determined as part of the LOGOS compression algorithm.

The memory required to store Q in (5) is exactly equal to the cost to store Z. The memory required to store R is approximately equal to the memory required to store Q (see examples below). The inverse of R required by (5) can be rapidly implement using a back substitution algorithm—this is the approach used below. Alternatively, it can be shown that the complexity (i.e., sparsity) of R⁻¹ is identical to that of R. Direct, sparse storage of R⁻¹ might provide computational advantages in certain instances relative to the back-substitution procedure used below. This possibility will be the subject of future investigations. Finally, the CPU time required to determine the factorization indicated on the right side of (6) from the LOGOS representation of \hat{Z} indicated in (4) is insignificant relative to the O(N²) time currently required to determine \hat{Z} from the original form of the impedance matrix.

Immediately below, is pseudo-code for the LOGOS direct solution algorithm outlined above. The next section summarizes representative examples of applying this algorithm to the TM_{z} scattering problem depicted in FIGS. 8A and 8B.

| | |
|---|---|
| Step 1 | Determine LOGOS representation (4) of Z; |
| | Comment: Store only \hat{Z} and the Lₗ. |
| Step 2 | Compute sparse QR factorization of \hat{Z}; |
| | Comment: Overwrite \hat{Z} with Q during factorization. |
| Step 3 | Use (5) to find current solution for a given. excitation; |
| | Comment: Implement R⁻¹ via back-substitution. |

6 Numerical Examples

See section 6 Numerical Example, found in EXHIBIT A.

7 Summary and Discussion

A sparse, QR-based direct solution scheme has been summarized and demonstrated for TM_{z} scattering from a sequence of dihedral arrays. The sparse solution algorithm follows directly from the sparsity structure induced by the multilevel LOGOS transform of the impedance matrix. It has been observed that the complexity of the resulting representation of the inverse operator scales approximately as O(N log N) at low to moderate frequencies. The proposed algorithm also provides significant efficiency gains relative to traditional direct solution strategies (e.g., LU decomposition) at higher frequencies, although the complexity scales more rapidly than O(N log N) in these cases.

### EXAMPLE 1.3

See also further Details in EXHIBIT B: Example Application

Expressions/equations are numbered consecutively within EXAMPLE 1.3 independently from the other EXAMPLES 1, 1.2, 1.4, and 1.5, and referenced as such, below.

A. Introduction

Numerical solutions of surface integral equation formulations of time-harmonic electromagnetic radiation and scattering from perfectly conducting targets involve solving linear systems of the form
Eⁱ=ZJ, (1)
where Z is the impedance matrix, the vector J contains the coefficients of the basis functions used to represent the electric currents on the surface of an obstacle, and the vector Eⁱ is determined by samples of an impressed electric field.

The use of surface integral equations to determine (1) usually leads to a full impedance matrix. As a result, the computational costs associated with standard solutions of (1) are prohibitive for electrically large problems, and it is often necessary to solve (1) iteratively using compression algorithms for the impedance matrix. However, the computational costs of fast iterative solvers can be significant when the impedance matrix is poorly conditioned, and when solutions are required for a large number of excitations.

In this Example 1.3 the focus is on providing a computationally efficient representation for the inverse of the impedance matrix, Z⁻¹. For many electrically large scattering problems since it is possible to group plane wave sources to form incident fields which excite surface currents that are nonzero over a small fraction of a large obstacle, one can determine a sequence of bandlimited linear transformations in the domain of the P-matrix which yield sparse representations for electrically large problems.

B. Convex Targets in Two Dimensions

The BTM discussed below is useful in a variety of two- and three-dimensional electromagnetic interaction problems. However, discussion in this Example 1.3 will be restricted to application of the BTM to boundary integral equation formulations of TM_{z} scattering from convex, perfect electrically conducting (PEC) rectangular cylinders. The scattering problems are formulated using electric (EFIE), magnetic (MFIE) and combined (CFIE) field integral equations.

In all of the examples, finite projections of the continuous integral equations are obtained using a point-matching moment method discretization with N basis and N testing functions. This reduces the EFIE to a matrix equation of the form
E_{z}ⁱ=ZJ_{z}, (2)
where the vector E_{z}ⁱ contains samples of the z-directed incident field on the surface of a target, and J_{z} is the vector of unknown coefficients for the z-directed surface current.

For the MFIE, a point-matching discretization yields a matrix equation of the following form:

$$( \frac{1}{2} I + K ) {J}_{z} = {J}_{z}^{i} , \qquad ( 3 )$$

where I is the N′ N identity matrix, and J′ is determined from the incident magnetic field. Finally, the CFIE is obtained by combining (1) and (3):

$$α Z {J}_{z} + ( 1 - α ) η ( \frac{1}{2} I + K ) {J}_{z} = - α {E}_{z}^{i} + ( 1 - α ) η {J}_{z}^{i} , \qquad ( 4 )$$

where h is the characteristic impedance of the background medium, and 0{tilde under (f)}a{tilde under (f)}1. For convenience, rewrite (4) as
C_{α}J_{z}=F_{α}ⁱ (5)
The definitions of the matrix C_{α} and the vector F_{α}ⁱ are evident from a comparison of (4) with (5). The desired solution can be represented as
J_{z}=C_{α}⁻¹F_{α}ⁱ (6)

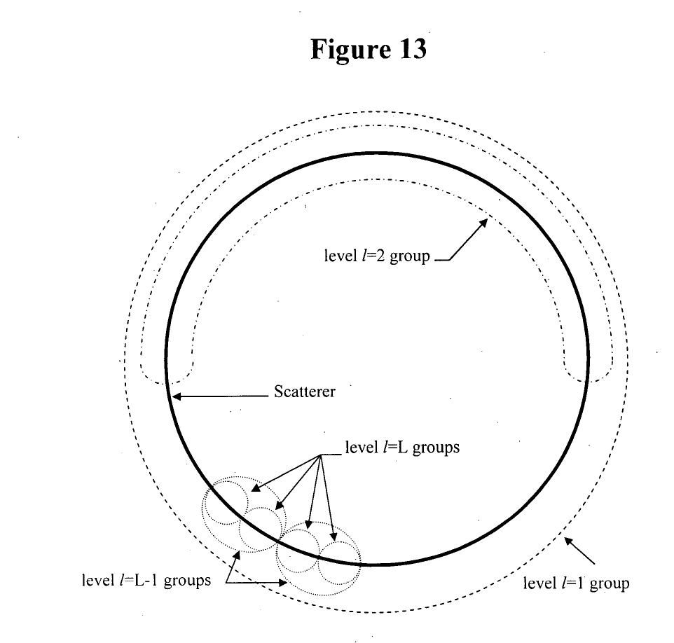

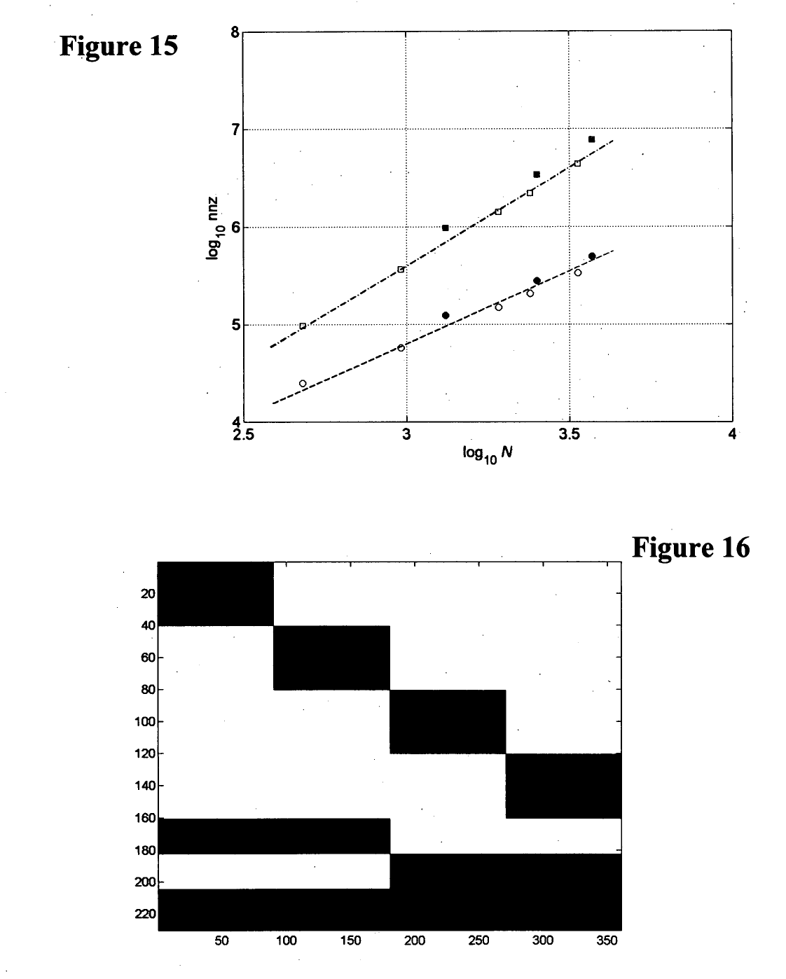

Over the next many pages of this Example 1.3, reference is made to several figures having been numbered in accordance with those found in EXHIBIT B hereto. As numbered in this Example 1.3, note that: FIG. 1 as referenced in Example 1.3 and EXHIBIT B is Figure II hereof; FIG. 2 as referenced in Example 1.3 and EXHIBIT B is FIG. 12 hereof; FIG. 3 in Example 1.3 and EXHIBIT B is FIG. 13 hereof; FIG. 4 in Example 1.3 and EXHIBIT B is FIG. 14 hereof; and FIG. 6 in Example 1.3 and EXHIBIT B is FIG. 15 hereof.

C. The P-Matrix

Consider the problem of compressing the plane wave response matrix (P-matrix), which defines the currents excited on the surface of a target by a spectrum of incident plane waves. While the P-matrix itself provides adequate information for a number of important applications, it is useful in developing more general representations for C_{α}⁻¹.

The P-matrix is obtained by assuming that the incident field can be represented as a sum of propagating plane waves:

$${E}_{z}^{i} ( ρ ) = \frac{1}{2 π} {\int }_{2 π} {ⅇ}^{jk \cdot ρ} {f}^{ i} ( ϕ ) ⅆ ϕ , \qquad ( 7 )$$

where ρ=\hat{x}x+ŷy, k=k(\hat{x}cosφ+ŷsinφ), k=2π/λ, and ƒⁱ(φ) is the plane wave spectrum of the incident field. For the TM_{z} polarization, the magnetic field satisfies the following relation at every point on the surface of a target:

$$\begin{matrix}{J}_{ z}^{ i} ( ρ ) {\vert}_{surface} = \hat{z} \cdot ( \hat{n} \times {H}^{ i} ( ρ ) ) \\ = \frac{1}{ jωμ} \frac{\partial {E}^{ i}}{\partial n} \\ = \frac{1}{ 2 πη} {\int }_{2 π} ( \hat{n} \cdot \hat{k} ) {ⅇ}^{ jk \cdot ρ} {f}^{ i} ( ϕ ) ⅆ ϕ\end{matrix} \qquad ( 8 )$$

where \hat{n} is the outward unit normal at a point on the surface of the target. In the following we assume that the coordinate origin used in (7) and (8) is located at the center of the convex target.

In the following denote the respective, discrete forms of (7) and (8) as
E_{z}ⁱ=Dfⁱ and J_{z}ⁱ=Dₙfⁱ (9)
where D and Dₙ are discrete representations of the continuous integral operator appearing in these equations. In the numerical examples considered below, the vectors E_{z}ⁱ, J_{z}ⁱ and fⁱ are obtained as point samples of their continuous counterparts. Similarly, the elements of D and Dₙ are point samples of e^{jk·p} and (\hat{n}·\hat{k})e^{jk·p} multiplied by 1/N_{φ}, where N_{φ} is the number of uniformly spaced samples used to discretize (7) and (8). Accurate representation of these operators requires that N_{φ} scales approximately linearly with the electrical size of the target (cf. equation (28) below).

With the definition
D_{α}=αD+(1−α)ηDₙ, (10)
we express (6 ) as
Jₛ=C_{α}⁻¹D_{α}fⁱ=P_{α}fⁱ, (11)
where
P_{α}=C_{α}⁻¹D_{α} (12)
specifies the coefficients of the surface current approximation excited by a weighted sum of incident plane waves. For this reason, P_{α} is referred to as the plane wave response matrix (P-matrix). If an exact discretization is used, the P-matrix will be independent of α. We have retained the subscript on P_{α} in (12) because, in practice, the numerical approximation obtained for the P-matrix will depend on the formulation used to represent the scattering problem.

FIG. 2 illustrates the plane wave response matrix for TM_{z} scattering from the rectangular target illustrated in FIG. 1 when α=10λ and b=3λ. The P-matrix was obtained using a CFIE formulation with α=½. Each column of the matrix in FIG. 2 provides an approximation of the electric current excited on the surface of the target for incident plane waves originating from φ=0 (the leftmost column) to φ=2π(1−1/N_{φ}) (the rightmost column). The first row of the P-matrix provides an approximation of the current excited on the first segment of the target due to each of the discretely sampled incident plane waves. The P-matrix is N×N_{φ} where N_{φ}=O(N) for electrically large targets.

D. Spatial Groups

The BTM discussed below relies on a multilevel spatial decomposition of points on the surface of a target. Because we have restricted our attention to TM_{z} electromagnetic scattering from convex cylinders, the target points can be uniquely ordered in the polar variable φ. The desired multilevel tree is obtained by recursively bisecting these points into nested groups. An illustration of the resulting multilevel spatial tree is provided in FIG. 3.

The number of levels in the multilevel binary tree will be denoted by L. The individual levels are indexed by l, l=1, . . . , L. The level l=1 is the root level of the tree. The root level consists of a single group containing all spatial samples. The number of groups at the lth level of the tree is M(l)=2^{l-1}, and the number of spatial samples in each group is approximately m(l)=N/M(l). The total number of levels, L, is chosen so that the level-L groups have a maximum dimension of approximately one wavelength.

The index i(l) is used to enumerate the groups at each level, i(l)=1, . . . , 2^{l-1}. In the remainder of this paper we will denote a matrix associated with a given group, i(l), at specific level, l, using notation of the form Xᵢ₍ₗ₎. The subscript i(l) is used to indicate both the level and the group number at that level with which the matrix is associated.

The two level-l groups contained by a given group at level-(l−1) are referred to as the level-l children of that level-(l−1) parent. Groups at level-L have no children, and the root group has no parent. For p>l, the level-p groups contained by a level-l group, i.(l), are referred to as the level-p descendants of i(l). This set is denoted d[i(l),p]. The set of d[i(l),l] is empty.

E. Beam Transform Method

For a given tolerance ε, the bandlimited BTM determines an order-ε compressed representation of the P-matrix using a basis of bandlimited plane wave modes which excite currents in a sequence of successively larger spatial regions. Section E.1 describes the local global solution (LOGOS) procedure used to determine incident plane wave modes which excite spatially localized current solutions that satisfy the global boundary conditions. A more efficient version of the LOGOS procedure based on bandlimited plane wave modes is outlined in Section E.2. The resulting multilevel compression scheme for the P-matrix is summarized in E.3.

E.1 LOGOS Modes

Let the cross sectional contour of a convex cylinder be divided into two regions based on the ith group at level-l (group i(l)). Let Region 1 consist of points on the surface of a target inside group i(l), and let Region 2 consist of the remaining points. Define the matrix D_{α,1} as that portion of the plane wave transform matrix (10) which specifies the currents incident on Region 1, and let D_{α,2} denote the remainder of D_{α}. Similarly, let the matrices C_{α,1l} and C_{α,2l} denote submatrices of C_{α} which specify the fields produced in Region 1 and Region 2, respectively, due to current sources in Region 1,. In the remainder of this section, we outline a procedure for determining the localizing plane wave modes which excite surface currents which are localized to Region 1 and satisfy the appropriate boundary conditions in Region 2.

Denote by fᵢ the set of plane wave modes which simultaneously satisfy the local boundary condition,
C_{α,1l}Jᵢ=D_{α,1}fᵢ, (13)
and the global boundary condition,
C_{α,2l}Jᵢ=D_{α,2}fᵢ (14)
Combining (13) and (14) provides a single local-global condition on these modes,
C_{α,21}C_{α,11}⁻¹D_{α,1}−D_{α,2})fᵢ=0 (15)
The fᵢ which satisfy (15) provide local solutions in Region 1 which satisfy the global radiation condition from Region 1 to Region 2. Since we are not interested in the trivial solution fᵢ=0, we augment (15) with the condition
D_{α,1}fᵢ≢0 (16)

The operators appearing in (15) and (16) are finite dimensional matrices, and there are generally no fᵢ which exactly satisfy these simultaneous conditions. To find fᵢ which approximately satisfy (15) subject to (16), we impose an approximate version of (15):
||(C_{α,21}C_{α,11}⁻¹D_{α,1}−D_{α,2})fᵢ||=ε²T, (17)
where
T=||D_{α,1}fᵢ|| (18)
The symbol ||·|| is used to indicate the 2-norm of a vector.

The fᵢ satisfying (17) can be determined from the singular value decomposition [3] of the augmented system

$$X = [ \begin{matrix}{C}_{α , 21} {C}_{α , 11}^{- 1} {D}_{α , 1} - {D}_{α , 2} \\ {D}_{α , 1}\end{matrix} ] , \qquad ( 19 )$$

which is an N×N_{φ} matrix. Let usv^{H} denote the order-ε expansion obtained by truncating the exact SVD of X to retain only those singular modes which satisfy
sᵢ>εmax(sᵢ), (20)
where the sᵢ indicate the singular values of X:
X=usv^{H}+O(ε) (21)

From (21) we observe that the matrix vs⁻¹ provides a linear transform of X composed of vectors ordered by the degree to which they contribute to the incident field on the surface of the target. Following [4], we seek an additional transform which sorts these modes by the degree to which their energy is localized within Region 1. Let \hat{u} denote the rows of u corresponding to observers located within Region 1. The desired localizing transform is obtained by performing an SVD of û,
USV^{H}=û (22)
Let Sᵢ denote the diagonal elements of S. Because û is obtained by truncating the unitary matrix u, the singular values Sᵢ are bounded from above by unity. Those singular values which are close to one correspond to modes which focus a majority of their energy within Region 1. We refer to those columns of V having singular values which satisfy
1−Sᵢ<ε² (23)
as modes which are localized within Region 1 to order ε. (As discussed in Section E.3, the numerical examples presented below will use a directional tolerance of ε³ instead of ε² in (23).)

Let \hat{V} indicate the subset of V with singular values Sᵢ satisfying (23). The columns of the matrix vs⁻¹\hat{V} provide a set of plane wave modes which satisfy (17) in Region 2 to order-ε. Let Λᵢ₍ₗ₎ denote the orthonormal basis which spans vs⁻¹\hat{V} (obtained, for example from a QR decomposition),
Λᵢ₍ₗ₎=orthonormal(vs⁻¹\hat{V}) (24)
The modes ζᵢ₍ₗ₎ excite local currents which satisfy global boundary conditions. We refer to the columns of Λᵢ₍ₗ₎ as local-global solution (LOGOS) modes.

The nonzero entries of the product
Bᵢ₍ₗ₎=PΛᵢ₍ₗ₎ (25)
are, to order-ε, located in rows corresponding to observation points in Region 1 (i.e., group i(l)). In fact, according to (23), for a given column of Bᵢ₍ₗ₎, the norm of the rows in that column associated with Region 1 is O(ε⁻²) larger than the norm of the remaining rows of the column. However, it follows from (21) that the condition number of Bᵢ₍ₗ₎ is O(ε⁻¹). this is the reason that the truncation parameter used in (17) and (23) is the square of the desired tolerance.

Our purpose in the remaining sections will be to use the spatial localization provided by the modes Λᵢ₍ₗ₎ to determine an efficient order-ε representation of the P-matrix. In particular, the contribution of the directional modes Λᵢ₍ₗ₎ to the P-matrix can be represented as
Pᵢ₍ₗ₎=Bᵢ₍ₗ₎Λᵢ₍ₗ₎^{H} (26)
Bᵢ₍ₗ₎ is evidently sparse relatively to Pᵢ₍ₗ₎ due to the spatial localization provided by the modes Λᵢ₍ₗ₎. However, the matrix Λᵢ₍ₗ₎ is not significantly sparser than Pᵢ₍ₗ₎, since the number of plane wave modes (N_{φ}) required to represent the P-matrix is proportional to the electrical size of a target. In the next section we consider the use of bandlimited functions to control the sparsity of Λᵢ₍ₗ₎.
E.2 Bandlimited LOGOS

At a fixed frequency, the electromagnetic bandwidth (BW) associated with a region of space having a maximum physical dimension d scales approximately as d/λ [5]:
BW(d)∝kd (27)
The number of spectral samples (N_{φ}) required to accurately represent these degrees of freedom to spatially separated observers if approximately [6]
N_{φ}(d)≈2kd+10ln(kd+π) (28)

Consider the problem of determining the localizing transform Λᵢ₍ₗ₎ when the electrical size of group i(l) (Region 1) is small relative to the remainder of the target (Region 2). If d₁ and d₂ indicate the maximum dimensions of Regions 1 and 2, then d₂>>d₁. The number of plane wave modes required to represent all incident current distributions generated in Region 1 by distant sources is approximately N_{φ}(d₁). This is the number of columns required to accurately represent the domain of D_{α,1} in (19).

The number of plane wave modes required to represent all incident current distributions in Region 2 is N_{φ}(d₂). Thus, the number of columns required to represent D_{α,1} and D_{α,2} in (19) is much larger than the number of columns required to accurately represent D_{α,1}. (Recall that D_{α,1} and D_{α,2} are submatrices of D_{α}.)

However, if we restrict our consideration to surface current solutions which are localized within Region 1, then the incident currents in Region 2 must cancel the fields radiated from Region 1 to Region 2. Since the number of degrees of freedom (DoF) in Region 1 is limited to N_{φ}(d₁), it follows that the number of DoF required to represent the fields incident on Region 2 is also on the order of N_{φ}(d₁). This suggests that, when the current solution is localized to Region 1 and d₂>>d₁, the number of angular modes required to represent D_{α,2} in (19) is similar to the number required for D_{α,1}.

Having established that the number of DoF required to represent the plane wave transforms D_{α,1} and D_{α,2} is roughly N_{φ}(d₁), appropriate discrete forms of the resulting, subsampled operators remain to be determined. It is well known that, if the coordinate origin is located at the center or Region 1, then the rows of D_{α,l} have a bandwidth on the order of kd₁ [2]. In this case D_{α,1} can be accurately represented by subsampling with N_{φ}(d₁) points. Let \hat{D}_{α,1} indicate the resulting matrix:
\hat{D}_{α,1}=D_{α,1}E(ρ₁)S(N_{φ}(d₂),N_{φ}(d₁)) (29)
In (29), ρ₁ indicates the center of Region 1, and e(ρ₁) is the diagonal operator which shifts the coordinate origin to the center of Region 1,
E(ρ₁)=diag(e^{-jk·pL}) (30)
The matrix s symbolizes the spectral subsampling operation applied to the rows of D_{α,2}E(ρ₁). In practice, the subsampling is accomplished by sampling the kernel of D_{α,2}E(ρ₁) at N_{φ} (d₁) points.

As suggested above, the number of spectral points used to represent D_{α,2} can also be reduced to approximately N_{φ}(d₁) points. However, because the rows of D_{α,2}E(ρ₁) are not bandlimited functions, the matrix \hat{D}_{α,2} cannot be obtained by subsampling E(ρ₁)D_{α,1}^{H} at N_{φ}(d₁) points. To avoid aliasing, we must first apply a low-pass filter:
\hat{D}_{α,2}=D_{α,2}E(ρ₁)F₁₂S(N_{φ}(d₂),N(d₁)) (31)
In (31), F₁₂ is an ideal low pass filter which eliminates all angular modes aliased by the subsampling operation.

Although (31) provides a reduced representation of D_{α,2}, its direct implementation requires that we first sample D_{α,2} at N_{φ}(d₂) points prior to filtering and subsampling. A more efficient implementation is obtained by expanding the plane wave kernel of D_{α,2}E(ρ₁) in a Fourier Series and retaining only those modes which are in the passband of F₁₂.

The Fourier expansion of the plane wave kernel is [7]

$${ⅇ}^{jk ( ϕ ) {δ}_{1}} = {\sum }_{l = - ∞}^{∞} {J}_{l} ( k {δ}_{1} ) {ⅇ}^{jl ( {ϕ}_{1} - π / 2 )} {ⅇ}^{- jl ϕ} , \qquad ( 32 )$$

where δ₁=(ρ−ρ₁) is the vector from the center or Region 1 to the point ρ. Since the left side of (32) is the kernel of D_{α,2}E(ρ₁) in (31), the elements of the filtered operator, \hat{D}_{α,2}, are obtained by truncating the sum on the right side of (32) to include only those Fourier modes in the passband of F₁₂. Finally, we note that if m terms are retained in the expansion, the cost to evaluate the left side of (32), at m uniformly sampled points in φ using the FFT is O(m log m).

With (29) and (31), the filtered form of (19) is

$$\hat{X} = [ \begin{matrix}{C}_{α , 21} {C}_{α , 11}^{- 1} {\hat{D}}_{α , 1} - {\hat{D}}_{α , 2} \\ {\hat{D}}_{α , 1}\end{matrix} ] , \qquad ( 33 )$$

which has dimension N×N_{φ}(d₁) and has a domain coordinate origin located at the center of Region 1. This is the form of the localizing condition which will be used in the numerical examples to follow. In the next section, we summarize a simple multilevel algorithm which uses the bandlimited, localizing beams obtained from (33) to compress the P-matrix.
E.3 Multilevel Implementation

Let Λ_{(L)} denote the collection of all bandlimited plane wave modes which excite currents localized to one of the M(L) spatial groups at the level-L. These modes are obtained by applying the LOGOS algorithm discussed above to the bandlimited condition (33). We represent this procedure as

$${\{ {\hat{X}}_{i ( L )} \}}_{i ( L ) = 1 ( L )}^{M ( L )} {\to }^{LOGOS} {Λ}_{( l )} , \qquad ( 34 )$$

where \hat{X}_{i(L)} is (33) for a given group at level-L. As indicated by (26), we obtain a projection of the P-matrix onto this basis as
P_{(L)}=B_{(L)}Λ_{(L)}^{H}, (35)
where B_{(L)}=PΛ_{(L)}

We would like to project the error, P−P_{(L)}, onto a set of modes localized at the parent level, l=L−1. However, a direct application of (33) at the parent level will yield a basis which contains modes already represented by λ_{(L)}. This can be avoided by first removing all level-L modes from the domain of \hat{X}_{i(L-1)}. If Λ_{d[i(L-1),L]} denotes the previously determined (via (34)) plane wave modes which localize currents within a level-L descendant of group i(L−1), then the reduced local-global condition for group i(L−1) is
\hat{R}_{i(L-1)}=\hat{X}_{i(L-1)}(I−Λ_{d[i(L-1),L]}Λ_{d[i(L-1),L]}^{H}) (36)
With the definition Λ_{d[i(l),l]}=0, the multilevel generalization of (36) is

$${\hat{R}}_{i ( l )} = {\hat{X}}_{i ( l )} {\prod }_{j = l}^{L} ( I - {Λ}_{d [ i ( l ) , j ]} {Λ}_{d [ i ( l ) , j ]}^{H} ) . \qquad ( 37 )$$

As with (34), Λ₍ₗ₎ is determined from \hat{R}ᵢ₍ₗ₎ using the LOGOS procedure,

$${\{ {\hat{R}}_{i ( l )} \}}_{i ( l ) = 1 ( l )}^{M ( l )} {\to }^{LOGOS} {Λ}_{( l )} \qquad ( 38 )$$

Having determined the Λ₍ₗ₎ via (38), the BTM approximation to the P-matrix is

$$P \approx {\sum }_{l = 1}^{L} {B}_{( l )} {Λ}_{( l )}^{H} , \qquad ( 39 )$$

where B₍ₗ₎ is the level-l matrix of beam footprints:

$${B}_{( l )} = {P}_{α} ( {\prod }_{j = l + 1}^{L} ( I - {Λ}_{( j )} {Λ}_{( j )}^{H} ) ) {Λ}_{( l )} . \qquad ( 40 )$$

The expansion (39) can be equivalently represented as:
P≈BΛ^{H} (41)
where B is the matrix obtained by concatenating all of the B₍ₗ₎. Similarly, the columns of Λ are obtained by concatenating the Λ₍ₗ₎.

It is important to recognize the multilevel BTM defined by (38) through (41) does not directly enforce orthogonality on either Λ or Λ₍ₗ₎. (The Λᵢ₍ₗ₎ are orthonormal due to (24).) This lack of orthogonality on the right side of (37) has been observed to reduce the efficiency of the BTM in some cases. However, as shown in the next section, it is possible to indirectly obtain an orthonormal basis (to order-ε) by increasing the directional tolerance on the right side of (23) from ε² to ε³.

The representation of the P-matrix provided by (41) is efficient for convex targets because both B and Λ have sparse representations. In the former case, the only nonzero elements retained in each column of B are within the single illuminated spatial region to which a given mode of Λ is directed. Although Λ is generally a full matrix, the columns of Λ are bandlimited functions and can be efficiently stored and manipulated in the spectral domain.

To compute the order-ε approximation of the current excited by an incident plane wave spectrum f^{inc} via (41), we use a plane wave translation and filtering procedure similar to that used in the disaggregation step of the MLFMA [2]. That is, the plane wave spectrum incident on the root group (l=1) is first projected onto the spectral modes defined at the root level, Λ₍ₗ₎, with the result providing the complex weights for the level-1 current modes, B₍ₗ₎. The weighted current modes are subsequently accumulated in the global surface current vector. Proceeding to the next (finer) level, the level-2 spectrum for each child of the root group is computed from the incident spectrum via spatial translation and low pass filtering. Each level-2 spectrum is then projected onto the local spectral modes, Bₗ₍₂₎, which are again accumulated in the global surface current vector. This procedure is repeated for all groups at all levels in the multilevel tree, proceeding from the coarsest level to the finest level.

F. Numerical Examples

Consider the problem of TM_{z} scattering from the cylinder illustrated in FIG. 1 when a=b. FIG. 4 illustrates the B and Λ matrices of (41) when α=50λ. A seven level (L=7) binary tree was used to form the nested spatial groups. The number of groups at the finest level was M(L)=64. The P-matrix was formed using a CFIE formulation with α=0.5 and a sampling density of twelve points per wavelength (N=2400). A tolerance of ε=10⁻² was used in the LOGOS procedure. The actual normalized RMS error in the difference P_{α}−BΛ⁺ was 5.1×10⁻³. The implementation of the LOGOS procedure for this example used a directional tolerance of ε³ instead of ε² in (23) (cf. Section E.3).

The total number of nonzero entries used to define B and Λ for the case considered in FIG. 4 is 2.08×10⁵. The number of nonzero entries in the P-matrix is 2.22×10⁶. The number of angular modes (i.e., beams) used for both b and Λ is 422. The number of singular modes which must be retained to obtain an SVD-based expansion of P_{α} with a similar relative RMS error (6.4×10⁻³) is 412. Thus, the number of modes used by the BTM expansion (41) is close to optimal in this case.

FIG. 6 displays the increase in the complexity of the BTM representation (41) as a function of N for square and rectangular cylinders sampled with twelve points per wavelength. The complexity of the BTM representation is defined as the number of nonzero (nnz) complex numbers required to store B and Λ. Similarly, the complexity of the P-matrix is defined as the number of nonzero entries in P_{α}. For both cases considered, the BTM complexity increases approximately as N^{1.5}, while the complexity of P_{α} increases approximately as N². The formulation and tolerances used for the cases reported in FIG. 6 are the same as those used in FIG. 4.

### EXAMPLE 1.4

See also Further Details in EXHIBIT C: Example Application

Expressions/equations are numbered consecutively within EXAMPLE 1.4 independently from the other EXAMPLES 1, 1.2, 1.3, and 1.5, and referenced as set forth, below.

1 Introduction

Numerical solutions of surface integral equation formulations of time-harmonic electromagnetic interactions with perfect electric conductors (PECs) require solving linear systems of the form
Eⁱ+ZJ=0, (1)
where Z is the N-by-N impedance matrix, the vector J contains the coefficients of the basis functions used to represent the electric currents on the conductor, and the vector Eⁱ is determined by samples of an impressed electric field. The focus of this Example 1.4 is presenting a sparse direct solution strategy for discretizations of (1) obtained for low-frequency, TMz scattering applications. . Herein, the phrase “low-frequency” is used to refer to a situation in which the maximum linear dimension of a scattering configuration is generally considered small relative to the wavelength of the harmonic excitation.

A LOGOS mode is a solution (J) of the global boundary condition (1) that is localized to order-ε within a smaller part of the global simulation domain. These modes can be divided into radiating and nonradiating types. Because discussion in this Example 1.4, is targeted for so-called low-frequency applications of (1), only nonradiating modes are incorporated in order to determine O(N) factored representations of Z.

A nonradiating LOGOS mode is defined as a solution to (1) in which both the surface current and the associated scattered fields are localized to the same small spatial region. Hereafter, a broadening has been done of previous definitions of nonradiating LOGOS modes to include solution modes in which the currents are localized to overlapping spatial regions. However, the scattered fields remain localized to non-overlapping spatial regions. Such modes are hereinafter referred to as overlapped localizing LOGOS (OLL) modes.

Over the next many pages of this Example 1.4, reference is made to several figures having been numbered in accordance with those found in EXHIBIT C hereto. As numbered in this Example 1.4, note that: FIG. 1 as referenced in Example 1.4 and EXHIBIT C is FIG. 1 hereof; FIG. 2 as referenced in Example 1.4 and EXHIBIT C is FIG. 3 hereof; FIG. 3 in Example 1.4 and EXHIBIT C is FIG. 4 hereof; FIG. 4 in Example 1.4 and EXHIBIT C is FIG. 5 hereof; the pseudo code identified as FIG. 5 and FIG. 6 in Example 1.4 and EXHIBIT C has been incorporated/reproduced above in connection with the Factorization Procedure (see also FIG. 2 hereof); and FIG. 7 in Example 1.4 and EXHIBIT C is FIG. 2 hereof.

2 Outline of Sparse Solution Strategy

Given an arbitrary set of linearly independent excitation vectors, Eⁱ, and a sparse representation of Z, we are interested in efficiently determining a sparse factored representation of Z, accurate to order-ε, which can be used to rapidly determine the corresponding solution vectors, J=−Z⁻¹Eⁱ.

FIG. 1 illustrates the structure of the solution strategy. The procedure begins by using a fast scheme to determine a sparse, O(N log N), SVD-based representation of Z from sparse samples of the underlying free-space TM_{z} kernel. The procedure used to determine the SVD-based representation from sparse samples of Z is known and will not be discussed further here. As indicated in the figure,, the relative RMS error between the compressed form and the actual impedance matrix is required to be O(ε²), where ε is the desired RMS error in the boundary condition (1).

The sparse, SVD-based representation is subsequently transformed into the O(N) sparse MLSSM (multilevel simply sparse method) representation summarized below. The details of the procedure used to determine the O(ε²) MLSSM representation of Z from the SVD-based representation will be communicated separately.

Turn, next, to the remaining two blocks of the solution procedure indicated in FIG. 1. In particular, the following discussion assumes the availability of an O(ε²) MLSSM representation of Z and proceeds to manipulate this into a factored form amenable to fast sparse implementations of Z⁻¹ via overlapped, nonradiating LOGOS modes.

3 Spatial Groups

The LOGOS factorization algorithm for the MLSSM representation of Z relies on a multilevel spatial decomposition of the underlying geometry. This is accomplished in the following examples using a multilevel quad-tree. The resulting spatial groupings are similar to those used to implement the multilevel fast multipole algorithm in two dimensions.

The number of levels in the quad-tree will be denoted by L. The individual levels are indexed by l, l=1, . . . , L. The level l=1 is the root level of the tree. The root level consists of a single group containing all spatial samples. The number of nonempty groups at the ith level of the tree is M(l), and the number of spatial samples in each group is approximately m(l)=N/M(l). The total number of levels, L, is chosen so that the smallest spatial group in each branch of the multilevel tree contains approximately ten points.

At a given level (level-l) of the tree, those groups having boundaries which touch the box bounding the ith group are referred to as the level-l near-neighbors of the ith group. (The ith group is also considered to be a near-neighbor to itself.) The remaining groups at level-l are referred to as distant (or non near-neighbor) groups.

In the following discussion it will at times be convenient to indicate the ith group at level-l using the notation i(l). Similarly, the notation Gᵢ₍ₗ₎ will be used to indicate the columns of a given matrix G associated with sources in the ith level-l group. The notation {i(l),n} will be used to indicate the set of all level-l groups which are near-neighbors of group i(l). Thus, the matrix G_{{i(l),n}} indicates the columns of G associated with source degrees of freedom located in groups which are near-neighbors of group i(l).

4 MLSSM Representation of Z

The multilevel simply sparse method (MLSSM) provides a compressed representation of the impedance matrix. The complexity of the MLSSM representation of Z is O(N) for electrically small configurations (this is demonstrated by-the numerical examples of Section 9). The MLSSM also provides a convenient representation of the LOGOS-based projections of Z indicated by (8) and (9) below.

The structure of the MLSSM is indicated by the following multilevel recursion:
Zₘ=\hat{Z}ₘ+Uₘ^{H}Zₘ₋₁Vₘ (2)
If the MLSSM recursion indicated by (2) is used to provide a multilevel compressed representation of Z in (1), the original impedance matrix is recovered from (2) when m=L (i.e., Z=Z_{L}).

In (2), \hat{Z}ₘ is the sparse matrix containing all near-neighbor interactions at level-m of the quad-tree which were not represented at a finer level of the tree. The matrices Uₘ and Vₘ are non-rectangular, orthonormal, block diagonal matrices which effectively compress interactions between non-touching groups at level- m of the quad-tree. This compression is accomplished by using a singular value decomposition to determine the minimum number of DoF (degrees of freedom) required to represent interactions between separated sources and observers.

The MLSSM representation (2) will be used in the following to compress both the impedance matrix, Z, and level-l projections of the impedance matrix (cf. (8) and (9)). In all such instances, (2) is valid for m=3, . . . , l. When m=2, equation (2) reduces to
Z₂=\hat{Z}₂ (3)
The matrices U₂ and V₂ are not defined in this case because all interactions at level-2 are between touching (i.e., near-neighbor) groups. For the same reason, the recursion indicated by (2) and (3) is not continued to level-1. The original impedance matrix is recovered from (2) when m=1=L:
Z=Z_{L} (4)
The MLSSM discussed above is a multilevel modification of the simply sparse method (SSM) previously discussed by Canning; see for example, F. X. Canning and K. Rogovin, “A universal matrix solver for integral-equation-based problems,” IEEE Antennas and Propagation Magazine, vol. 45, pp. 19-26, 2003.

The LOGOS-based factorization procedure discussed below assumes the availability of an O(ε²) L -level MLSSM representation of Z. Given this representation, the remainder of this Example 1.4 outlines a sparse, O(ε) factored representation of Z via overlapped, localizing LOGOS modes.

5 Overlapped Localizing LOGOS Modes

LOGOS-based sparse factorization algorithms for Z at low frequencies utilize nonoverlapped, localizing LOGOS modes obtained by analyzing the impedance matrix to determine surface current modes satisfying (1) for which both the current, J, and the scattered field, ZJ, are localized (within O(ε)) to identical spatial groups. Due to the reliance on standard, nonoverlapping, multilevel spatial decompositions (quad- and oct-trees), these algorithms have computational efficiencies of approximately O(N^{1.5}) in two dimensions and O(N²) in three dimensions.

These computational efficiencies are a consequence of constraining LOGOS modes to nonoverlapping spatial groups. For example, consider the two-level quad-tree decomposition of a general two-dimensional target illustrated in FIG. 2 of EXHIBIT C also FIG. 3 hereof. Assuming a total of N unknowns and a uniform discretization of the shaded region indicated in the figure, it follows that there are O(\sqrt{N}) degrees of freedom along any line which crosses through the center of the scatterer. Two such boundaries are introduced at level-2 of the quad-tree decomposition of the target. Any DoF which might be localized in a small neighborhood which intersects one of the level-2 boundaries cannot be captured until the root level of the quad-tree is reached. Since there are about O(\sqrt{N}) such DoF (for large N at low frequency), it follows that the computational complexity of previously reported LOGOS factorization algorithms are bounded from below by O(N^{1.5}) for general targets in 2-D. A similar argument demonstrates that the complexity of previously reported 3-D LOGOS factorization algorithms is bounded from below by O(N²).

These complexities can be significantly reduced by expanding Z in a basis of overlapped localizing LOGOS (OLL) modes. An OLL mode is defined by a source (J) which is generally confined to a larger spatial region than the scattered field (ZJ). The specific OLL mode definition used in this Example 1.4 is provided in FIG. 3 of EXHIBIT C; also FIG. 4 hereof. As indicated in the figure, at level-l, an overlapped localizing LOGOS mode associated with group i(l) is defined as a current (J) which is nonzero in the set of near-neighbor groups, {i(l),n}, and produces a scattered field, ZJ, which is nonzero only within the self group, i(l).

The LOGOS-based factorization algorithm described below uses a multilevel basis of these OLL modes to obtain a sparse factorization of the MLSSM representation of Z.

LOGOS Factorization of MLSSM Representation of Z

The LOGOS-based factorization strategy summarized in this section begins with a recapitulation of the basic features of the LOGOS-based Schur factorization algorithm.

6.1 LOGOS-based Schur factorization

The matrix
Λₗ=[Λₗ^{(L)},Λₗ^{(N)}] (5)
indicates the decomposition of the columns of the level-l LOGOS transformation (Λᵢ) into current modes that generate scattered fields which are (Λₗ^{(L)}) and are not (Λₗ^{(N)}) localized within a single level-l group. A similar segregation of the columns of the associated projection matrix, Pₗ, is also possible (Pₗ is used to indicate-the projection operator herein):
Pₗ=[Pₗ^{(L)},Pₗ^{(N)}] (6)

The block diagonal matrix Pₗ is determined by the (localized) scattered fields, ZΛᵢ^{(L)}. Notice in (5) and (6) that the non-italicized superscript (L) is used to indicate portions of the operators Λₗ and Pₗ associated with LOGOS modes that generate scattered fields localized to a single level-l group. The superscript (N) is used to indicate quantities with degrees of freedom (DoF) that are not localized to a single level-l group.

With these definitions, the level-l impedance matrix can be represented as

$${Z}_{l + 1}^{( NN )} = {( {P}_{l}^{H} )}^{- 1} {P}_{l}^{H} {Z}_{l + 1}^{( NN )} {Λ}_{l} {Λ}_{l}^{- 1} \approx {( {P}_{l}^{H} )}^{- 1} [ \begin{matrix}I & {Z}_{l}^{( L N )} \\ 0 & {Z}_{l}^{( NN )}\end{matrix} ] {Λ}_{l}^{- 1} , \qquad ( 7 )$$

where the approximation is accurate to O(ε). (Observe that the level-l transformations Λ₁ and Pₗ are applied to the level-(l+1) operator Zₗ₊₁^{(NN)}.) When l=L recover the impedance matrix: Z=Z_{L+1}^{NN)}.

The submatrices Zₗ^{(LN)} and Zₗ^{(NN)} in (7) are defined in terms of the components of Λᵢ and Pₗ,
Zₗ^{(LN)}=(Pₗ^{(L)})^{H}Zₗ₊₁^{(NN)}Λₗ^{(N)}, (8)
Zₗ^{(NN)}=(Pₗ^{(N)})^{H}Zₗ₊₁^{(NN)}Λₗ^{(N)} (9)
The submatrix Zₗ^{(LN}) indicates the simultaneous projection of (i) the domain of Zₗ₊₁^{(NN)} onto non-localizing level-l LOGOS modes, Λₗ^{(N)}, and (ii) the range of Zₗ₊₁^{(NN)} onto the conjugate of the scattered fields Zₗ₊₁^{(NN)}Λₗ^{(L)}. The matrix Zₗ^{(NN)} is similarly interpreted. The dimensions of the submatrices appearing on the right side of (7) are determined by the number of local (L) and nonlocal. (N) LOGOS modes determined at level-l, which in turn depends on the properties of the underlying scattering problem.

A Schur decomposition (indicated by (5) through (9) above) is incorporated, but is based on the overlapped localizing LOGOS (OLL) modes discussed in the previous section. One primary difference introduced is in the structure of the submatrix Λₗ^{(L)} of Λₗ. The matrices Λₗ and Pₗ used with the Schur factorization algorithm were both permuted block diagonal matrices for all l. Due to the present use of the overlapping LOGOS modes, the Λₗ obtained in the algorithm reported in this paper are no longer block diagonal. FIG. 4 of EXHIBIT C—and, as mentioned above—this is FIG. 5 hereof, illustrates the typical structure of the Λ₁. It is evident from the figure that the structure of the Λₗ^{(L)} component of Λₗ is no longer block diagonal. However, the portion of Λₗ associated with modes that are not localized to level-l (i.e., Λₗ^{(N)}) remains block diagonal. Similarly, due to the manner in which the overlapped localizing LOGOS modes have been defined (see Section 5 of this Example 1.4), the projection operators Pₗ remain block diagonal.

Hence, apart from the modification of Λₗ resulting from use of overlapped localizing LOGOS modes to define Λₗ^{(L)}, the structure of the multilevel Schur factorization algorithm remains unchanged. That algorithm consists in recursively applying the factorization strategy indicated by (7) to the submatrices Zₗ^{(NN)} obtained at each level of the recursion. In this way, a factored representation of Z is determined which is defined by the matrices Λₗ, Pₗ, Zₗ^{(LN)} and the matrix Z₃^{(NN)} obtained at level-3, at which level the multilevel recursion stops.

In order to render this overlapped factorization algorithm more computationally efficient than previously reported results, two issues are addressed:
1. Define a fast algorithm capable of determining the overlapped localizing modes (used to define Λ₁ and Pₗ at each level) from the Zₗ^{(NN)}.
2. A sparse storage format is required for the Zₗ^{(LN)} and the intermediate Zₗ^{(NN)} operators.
   6.2 Sparse Representations of Zₗ^{(LN)} and Zₗ^{(NN)}

The MLSSM provides a convenient format to store the impedance matrix, Z, and its projections, Zₗ^{(LN)} and Zₗ^{(NN)}, at each level of the multilevel tree. To illustrate, consider the level-l projection of Zₗ₊₁^{(NN)} indicated by (7). Assume that the matrix Zₗ₊₁^{(NN)} on the left of this equation has an l-level MLSSM representation with the form indicated by (2)
Zₘ=\hat{Z}ₘ+Uₘ^{H}Zₘ₋₁Vₘ, (10)
where 3≦m≦l. In this case, Zₗ₊₁^{(NN)} is recovered from (10) when m=l: Zₗ₊₁^{(NN)}=Z₁.

As discussed above, the matrices Λₗ and Pₗ are (permuted) block diagonal, except for the columns of Λₗ which correspond to overlapped level-l localizing modes (i.e., the submatrix Λₗ^{(L)}). Furthermore, the diagonal blocks of Λₗ^{(N)} and Pₗ are coincident with the diagonal blocks of Uₗ and Vₗ obtained from the MLSSM representation (10) when m=l. Hence, the block diagonal portions of Λₗ and Pₗ can be rapidly applied to the MLSSM representation of Zₗ₊₁^{(NN)} by applying them only to the exterior Uₗ and Vₗ matrices and the sparse near-neighbor operator \hat{Z}ₗ obtained from (10) when m=l.

In this way, the MLSSM representation of Zₗ^{(NN)} in (7) is obtained from the MLSSM representation of Zₗ₊₁^{(NN)} indicated by (10) as

$$\begin{matrix}{Z}_{l}^{( NN )} = {( {P}_{l}^{( N )} )}^{H} {Z}_{l + 1}^{( NN )} {Λ}_{l}^{( N )} \\ = {( {P}_{l}^{( N )} )}^{H} ( {\hat{Z}}_{l} + {U}_{l}^{H} {Z}_{l - 1} {V}_{l} ) {Λ}_{l}^{( N )} \\ = {\hat{Z}}_{l}^{( NN )} + {( {U}_{l}^{( N )} )}^{H} {Z}_{l - 1} {V}_{l}^{( N )} ,\end{matrix} \qquad ( 11 )$$

where \hat{Z}ₗ^{(NN)}=(Pₗ^{(N)})^{H}\hat{Z}ₗΛₗ^{(N)}, Uₗ^{(N)}=UₗPₗ^{(N)}, Vₗ^{(N)}=VₗΛₗ^{(N)}, and Zₗ₋₁ is unaffected by the projections. The MLSSM representation of Zᵢ^{(LN)} is similarly obtained.

At this point is it useful to make two observations. First, notice that the non block-diagonal portion of Λₗ (Λₗ^{(L)}, cf. FIG. 4) is not used in obtaining the matrices Zₗ^{(LN)} and Zₗ^{(NN)} required by the factorization (7). (The effect of Λₗ^{(L)} is to generate the submatrices I and O in (7).) This is essential to maintaining the basic, nested structure of the MLSSM representation at each level of the recursive factorization indicated by (7).

Secondly, we observe that the multilevel factorization algorithm of [7] applies the LOGOS factorization indicated by (7) to the Zₗ^{(NN)} obtained at successively coarser levels of the multilevel tree. For example, the next step in the multilevel LOGOS-based Schur factorization of (7) will consist of determining Λₗ₋₁ and Pₗ₋₁ from, and applying them to, Zₗ^{(NN)}. Because Λₗ₋₁ and Pₗ₋₁ must be defined on groups at level-(l−1), it is necessary to collapse the l-level MLSSM representation of Zₗ^{(NN)} in (7) to an (l−1)-level MLSSM representation prior to determining Λₗ₋₁ and Pₗ₋₁. This collapse of the MLSSM representation is efficiently accomplished by expanding Zₗ₋₁ in the last line of (11) to obtain

$$\begin{matrix}\begin{matrix}{Z}_{l}^{( NN )} = {\hat{Z}}_{l}^{( NN )} + {( {U}_{l}^{( N )} )}^{H} {\hat{Z}}_{l - 1} {V}_{l}^{( N )} + \\ {( {U}_{l}^{( N )} )}^{H} {( {U}_{l - 1} )}^{H} {Z}_{l - 2} {V}_{l - 1} {V}_{l}^{( N )} \\ = {\hat{Z}}_{l - 1}^{( NN )} + {( {U}_{l - 1}^{( N )} )}^{H} {Z}_{l - 2} {V}_{l - 1}^{( N )} ,\end{matrix} \\ where & ( 12 ) \\ {\hat{Z}}_{l - 1}^{( NN )} = {\hat{Z}}_{l}^{( NN )} + {( {U}_{l}^{( N )} )}^{H} {\hat{Z}}_{l - 1} {V}_{l}^{( N )} , & ( 13 ) \\ {U}_{l - 1}^{( N )} = {U}_{l - 1} {U}_{l}^{( N )} , & ( 14 ) \\ {V}_{l - 1}^{( N )} = {V}_{l - 1} {V}_{l}^{( N )} . & ( 15 )\end{matrix}$$

Due to the nested nature of the multilevel quad-tree used to define the MLSSM representation, the matrices Uₗ₋₁^{(N)} and Vₗ₋₁^{(N)} of (14) and (15) are block diagonal, with each diagonal block corresponding to a single level-(l−1) group. Similarly, \hat{Z}ₗ₋₁^{(NN)} is a spare matrix whose nonzero entries correspond only to interactions between near-neighbors at level (l−1). The remaining component of Zₗ^{(NN)} in (12), Zₗ₋₂, is unchanged from its original definition in (10). consequently, equation (12) is an (l−1) level MLSSM representation of Zₗ^{(NN)} (with the minor caveat that Uᵢ₋₁^{(N)} and Vₗ₋₁^{(N)} are not longer orthonormal transformations).

The fact that the Schur decomposition (7) yields submatrices Zₗ^{(NN)} that can be collapsed to an MLSSM representation at the next coarser (i.e., parent) level is significant. It implies that if we are given an algorithm for computing OLL modes from the MLSSM representation of a general matrix, this algorithm can be applied repeatedly to the blocks Zₗ^{(NN)} resulting from the decomposition (7) at different levels of the quad-tree. Due to the upper triangular nature of (7), this in turn yields a factored representation of the impedance matrix.

6.3 Efficient Determination of Overlapped Localizing Modes

Given the LOGOS transformation matrices, Λₗ, associated with each of the Zₗ^{(NN)}, the LOGOS-based Schur decomposition algorithm outlined above provides an efficient method of determination a sparse, factored representation of the impedance matrix. In this section we describe an efficient algorithm for determining the OLL modes (and thus the Λₗ) from the MLSSM representation of the impedance matrix and its projections.

To motive this algorithm, Section 6.3.1 summarizes the original procedure [3,5] used to determine localizing LOGOS modes from the full columns of the impedance matrix. In so doing, we also make the minor extension of using the associated LOGOS mode calculation algorithm to find the OLL modes described above. (References [3,5] only consider the determination of non overlapping modes from full columns of the impedance matrix.) Section 6.3.2 demonstrates the existence of an efficient alternative to the procedure used to find LOGOS modes in Section 6.3.1. The specific OLL mode calculation algorithm used in the numerical examples of Section 9 is finally outlined in Sections 6.3.3 and 6.3.4.

6.3.1 Original Algorithm

Consider the determination of overlapped localizing LOGOS modes associated with group i at level-l, i(l), from Zᵢ₊₁^{(NN)}. (Recall that, as indicated by (7), level-l, LOGOS modes are used to project the level-(l+1) matrix Zₗ₊₁^{(NN)}.) Let the submatrix Z_{{i,(l),n}}^{(NN)} indicate the (full) columns of Zₗ₊₁^{(NN)} associated with sources located inside group i(l) and its near-neighbors. The SVD-based LOGOS mode calculation procedure described in [3, 5] can be straightforwardly applied to Z_{{i(l),n}}^{(NN)} in order to determine excitation modes spanning group i(l) and its neighbors which generate scattered fields localized (to O(ε)) within group i(l). To summarize this procedure, let
Z_{{i(l),N}}^{(NN)}=u s v^{H} (16)
indicate the SVD of Z_{{i(l),n}}^{(NN)}, and let uᵢ₍ₗ₎ indicate rows of the unitary matrix u associated with observers located in group i(l). Because uᵢ₍ₗ₎ is a submatrix of a unitary matrix, an additional SVD of uᵢ₍ₗ₎ suffices to identify transformations of the original matrix, Z_{{i(l),n}}^{(NN)}, which generate scattered fields localized only to group i(l)[3, 5].

The primary computational limitation of this algorithm for determining OLL modes arises from the need to compute the SVD indicated by (16). For example when l=L, Z_{{i(L),n}}^{NN)} has N rows, and O(N) such decompositions are required (since the number of level-L groups is O(N)). these considerations indicate that computing the overlapped LOGOS modes at level-L will require O(N²) operations using the procedure reported in [3,5]. The remainder of Section 6.3 summarizes a more efficient procedure which can be used to determine the overlapped localizing LOGOS modes at all levels (l=3, . . . , L). However, in order to simplify the discussion, we only explicitly consider the efficient determination of OLL modes at the finest level (l=L) of the tree, which involves the original impedance matrix, Z_{L+1}^{(NN)}=Z. Extension of the results to coarser levels (l<L) is straightforward, as indicated in Section 6.3.5.

6.3.2 Motivation of an Efficient Alternative

To motive a computationally efficient procedure for determining the required OLL modes, consider decomposing the columns of Z associated with group i(L) and its near-neighbors as

$${Z}_{\{ i ( L ) , n \}} = [ \begin{matrix}{Z}_{\{ i ( L ) , n \}}^{( n )} \\ {Z}_{\{ i ( L ) , n \}}^{( f )}\end{matrix} ] , \qquad ( 17 )$$

where Z_{{i(L),n}}⁽ⁿ⁾ indicates those rows of Z_{{i(L),n}} associated with all observers contained by level-L groups that are near-neighbors of at least one of the groups in the set {i(L),n}. The matrix Z_{{i(L),n}}^{(f)} contains the remaining rows of Z_{{i(L),n}}, which are associated with observers located in groups that are separated from group i(L) and all of its near-neighbors by at least one level-L group.

Recall that, for sufficiently long wavelengths, only O(1) DoF (degrees of freedom) are required to represent the fields radiated by sources located inside group i(L) and its near-neighbors to separated observers within a given tolerance [12]. From this fact it follows that the number of modes that must be retained in the SVD of Z_{{i(L),N}}^{(f)} to maintain an O(ε²) representation is similarly O(1) (i.e., the number of required modes is independent of the number of sources contained by group i(L) and its near-neighbors):
Z_{{i(L),n}}^{(f)}=u^{(f)}S^{(f)}(V^{(f)})^{H}+O(ε²), (18)
with s^{(f)} and O(1)×O(1) matrix. Inserted in (17), this provides

$${Z}_{\{ i ( L ) , n \}} = [ \begin{matrix}I & 0 \\ 0 & {u}^{( f )}\end{matrix} ] [ \begin{matrix}{Z}_{\{ i ( L ) , n \}}^{( n )} \\ {{s}^{( f )} ( {v}^{( f )} )}^{H}\end{matrix} ] + O ( {ɛ}^{2} ) . \qquad ( 19 )$$

Because the leading matrix in (19) is unitary, the desired OLL modes can be determined by applying the original SVD-based calculation of [3, 5] (indicated above by (16) and the associated discussion) to a reduced submatrix, Z_{{i(L),n}}^{(x)}, instead of the original submatrix Z_{{i(L),n}} where

$${Z}_{\{ i ( L ) , n \}}^{( r )} = [ \begin{matrix}{Z}_{\{ i ( L ) , n \}}^{( n )} \\ {{s}^{( f )} ( {v}^{( f )} )}^{H}\end{matrix} ] = [ \begin{matrix}{Z}_{\{ i ( L ) , n \}}^{( n )} \\ {\tilde{Z}}_{\{ i ( L ) , n \}}^{( f )}\end{matrix} ] , \qquad ( 20 )$$

and we have used
\tilde{Z}_{{i(L),n}}^{(f)}=s^{(f)}(V^{(f)})^{H} (21)
The advantage of applying the original, SVD-based analysis of [3, 5] to (20) rather than to Z_{{i(L),n}} is that the former has dimension O(1)×O(1)the dimension of the latter is N×O(1).

Having thus established that it is possible to determine overlapped LOGOS modes via an SVD-based analysis of the reduced matrix Z_{{i(L),n}}^{(x)}, we continued by specifying a computationally efficient procedure for determining the reduced representation (20) from a sparse representation of Z. In particular, as suggested by FIG. 1, we outline an efficient algorithm for determining Z_{{i(L),n}}^{(x)} and subsequently Λ_{L}) from the MLSSM representation of Z. The discussion of this algorithm is contained in the following two subsections. Section 6.3.3 summarizes an algorithm with an O(N) memory complexity for determining Z_{{i(L),n}} from the MLSSM representation of Z. Section 6.3.4 discusses a modified version of this algorithm will significantly improved CPU performance.

6.3.3 Computing Z_{{i(L),N}}^{(r)} from MLSSM Representation of Z

As indicated by (20), Z_{{i(L),n}}^{(r)} is determined by the submatrices Z_{{i(L),n}}⁽ⁿ⁾ and \hat{Z}_{{i(L),n}}^{(f)}. Because Z_{{i(L),n}}⁽ⁿ⁾ is O(1)×O(1), in the numerical examples reported below this part of Z_{{i(L),n}}^{(r)} is simply computed by directly expanding the relevant portion of the MLSSM representation (2) for Z=Z_{L+1}^{(NN)}. Computing \hat{Z}_{{i(L),n}}^{(f)} is somewhat more complicated, and the pseudo-code for the algorithm described in this section is indicated in FIG. 5.

The basic idea behind the algorithm is to build up \hat{Z}_{{i(L),n}}^{(f)} for a given level-L group, i(L), by determining the contributions to this matrix due to non near-neighbor interactions occurring at the coarsest possible levels of the quad tree. This is indicated by the loop, l=3: L, specified as item 2 in FIG. 5. For a given set of source groups, {i(L),n}, at each level, l, the algorithm subsequently loops (item 2b) over all observer groups, j(l), which satisfy the following two conditions:
1. The observer group j(l) is not a near-neighbor to any of the level-l parents of any of the groups contained in the set {i(L),n}.
2. The corresponding interactions between the source groups, {i(L)}ₘ, and the observer group, j(l), have not previously been incorporated at a coarser level.
   For each level-l group satisfying these two conditions, the matrix A_{j(l,i(L)}, which defines the DoF radiated from the source region to the observer group j(l), is extracted from the MLSSM representation of Z and appended to matrix A_{l,i(L)} (item 2bi). The later matrix (A_{l,j(L)}) is used to accumulate the A_{j(l,k(L)} for all j(l).

The matrix A_{j(l),i(L)} is represented in terms of the MLSSM representation of Z as the nonzero part of
A_{j(l),i(L)}=Iⱼ₍ₗ₎(Uₗ^{H}Zₗ₋₁VₗTₗ)I_{{i(L),n}}, (22)
where the matrices Tₗ are defined by the MLSSM source transformations:
Tₗ₋₁=VₗTₗ, 23)
with T_{L} and N×N identity matrix, T_{L}=I_{N×N}. In (22), I_{{i(L),n}} is a matrix with ones on its diagonal for columns associated with sources located in groups {i(L),n}. All other entries of I_{{i(L),n}} are zero. Iⱼ₍ₗ₎ is similarly defined, having ones in the diagonal entries associated with observers located in group j at level-l. These exterior matrices are used in (22) to indicate extraction of the appropriate rows and columns from the MLSSM representation of the level-l DoF radiated from groups {i(L),n} to distant observers in j(l). In the numerical examples reported in Section 9, the extraction indicated by these operators is implemented by extracting only those elements of the MLSSM representation of Z which provide a nonzero contribution to A_{j(l,i(L)}.

After completing the loops over all of the level-l observer groups, and before proceeding to incorporate interactions defined at the next finer level of the tree, the accumulated matrix A_{l,j(L)} is compressed (item 2c of FIG. 5) using an SVD. This is accomplished by first computing the O(ε²) representation of the existing A_{l,j(L)} matrix (A_{l,(L)}=usv^{H}+O(ε²)) followed by the replacement
A_{l,j(L)} [symbol] sv^{H} (24)
As indicated in item 2d of FIG. 5, the compressed form of A_{l,i(L)} is subsequently appended to \hat{Z}_{{i(L),n}}^{(f)}, and the foregoing procedure is repeated at the next finer level of the quad-tree.

Finally, after completing the loop over the levels, an O(ε²) SVD representation of the matrix \hat{Z}_{{i(L),n}}^{(f)} is computed (cf. (18), followed by the replacement (item 3)
\hat{Z}_{{i(L),n}}^{(f)} [symbol] S^{(f)}(V^{(f)})^{H} (25)
At this point, \hat{Z}_{{i(L),n}}^{(f)} provides a mapping from sources in groups {i(L),n} to the DoF necessary to represent these sources to distant observers located in all groups at levels 3 to L which are not near-neighbors to any of the source groups, {i(L),n}. Finally, by augmenting the matrix \hat{Z}_{{i(L),n}}^{(F)} with the near-neighbor interaction matrix, Z_{{i(L),n}}⁽ⁿ⁾, we obtain the desired, O(1)×O(1), reduced matrix of (20), which can subsequently be used to determine the overlapped localizing LOGOS modes associated with group i)L).

Because it relies on the sparse MLSSM representation of Z, the algorithm just described for Z_{{i(L),n}}^{(r)} has an O(N) memory complexity of low frequency. However, the CPU cost of the algorithm is unnecessarily high due to a large number of repeated computations performed in computing the \hat{Z}_{{i(L),n}}^{(f)} matrices. These costs can be reduced by computing and storing the data required to form the A_{l,i(L)} in FIG. 5. Fortunately, this requires only a modest increase in the total memory requirement.

6.3.4 A CPU Efficient Algorithm for the Z_{{i(l),n}}^{(f)} matrices from the MLSSM representation of Z, it is useful to represent A_{j(l),i(L)} of (22) as the product of two matrices,
A_{j(l),i(L)}=X_{j(l),P(l,i(L))}T_{P(l,i(L)),i(L)}, (26)
where
X_{J(l),P(l,j(L))}=Iⱼ₍ᵢ₎Uₗ^{H}Zₗ₋₁VₗI_{P(l,i(L))}, (27)
T_{P(l,j(L)),i(L)}=I_{P(l,j(L))}TₗI_{{i(L),n}}, (28)
and Tₗ was defined in (23).

In (27) and (28), the symbol P(l,i(L)) is used to indicate all groups which are level-l parents of at least one group in the set {i(L),n}. I_{P(l,i(L))} is a matrix with ones on its diagonal for columns associated with these level-l groups. All other entries of I_{P(l,i(L))} are zero. Thus, the matrix T_{P(l,i(L)),i(L)} transforms the DoF in groups {i(L),n} to the associated nonzero level-l DoF required for interactions with distant groups. The matrix X_{j(l),P(l,j(L))} contains all level-l interactions between observer group j(l) and the level-l source groups which are parents of at least one group in the set {i(L),n}.

Using the definitions indicated in (26) to (28), FIG. 6 summarizes a more CPU efficient version of the algorithm reported in FIG. 5. The computational advantages of the improved algorithm are consequences of two modifications:
1. The matrices T_{P(l,i(L)),i(L)} are field (item 1b in FIG. 6) and applied (item 2b ) only once for each different source group.
2. The coarse level interaction matrices, X_{l,P(l,i(L))}, are only recomputed (item 2a) if they have not been previously stored (item 2aiv) subsequent to calculation for a different source group.

The CPU advantages of the first modification are evident. For a given i(L), the algorithm in FIG. 5 effectively requires re-computing T_{P(l,j(L)),i(L)} for each different j(l), whereas the modified algorithm in FIG. 6 only requires that T_{P(l,i(L)),i(L)} be computed once for each i(L). Furthermore, the additional memory costs introduced by this modification are negligible. It is never necessary to store more than O(log N) of the T_{P(l,i(L)),i(L)} at a given time in the calculation, and the T_{P(l,i(L)),i(L)} are O(1×o(1) at low frequency.

The savings obtained by the second modification listed above are more significant than those obtained from the first. However, these larger CPU savings are obtained at the expense of an increase (approximately ten percent) in the overall memory required by the algorithm.

The CPU savings provided by the second modification follow from the fact that many of the X_{l,P(l,i(L))} are identical to one another, both at a given level (level-L in the present case), and across multiple levels. These redundancies are a simple consequence of the fact that, for l<L, multiple sets of level-L groups (i.e., the {i(L),n}) have the same set of level-l parents. This fact implies that may of the X_{l,P(l,j(L))} required by (26) can be stored and reused to construct the \hat{Z}_{{i(L),n}}^{(f)}. In contrast, the algorithm of FIG. 5 effectively requires computing each of the X_{l,P(l,i(L))} from scratch (i.e., via the MLSSM recursion indicated in (22) and the loop over the j(l) in FIG. 5) for each \hat{Z}_{{i(L),u}}^{(f)}.

The additional memory required to store all of the X_{l,P(i,t(L))} in the algorithm of FIG. 6 is a relatively small, though not insignificant, fraction of the total memory. For all of the numerical examples reported in Section 9, the total memory required to store the X_{l,P(l,j(L))} is less than ten percent of the total memory required by the factorization algorithm. At low frequencies, this memory requirement was observed to scale approximately as O(N) for large N.

Once each \hat{Z}_{{i(L),n}}^{(f)} has been computed via the algorithm indicated in FIG. 6, the reduced matrix Z_{{i(L),n)}^{(r)} of (20) can be formed by augmenting \hat{Z}_{∴i(L),n}}^{(f)} with Z_{{i(L),n}}⁽ⁿ⁾. As indicated at the beginning of the previous subsection, the cost of the latter operation is O(1) for each i(L). Finally, given Z_{{i(L),n}}^{(r)}, the SVD-based analysis of [3, 5] can be used to determine the overlapped LOGOS modes associated with group i(L) in O(l) operations.

6.3.5 Multilevel LOGOS Mode Calculation

The previous subsections outline the algorithm used in the following numerical examples to determine the Z_{{i(L),n}}^{(r)}. Once the reduced matrices have been thus determined, the procedure used to calculate the corresponding elements of Λ_{L} and P_{L} from the Z_{{i(L),n}}^{(r)} is essentially unchanged from that described in [3, 5].

The foregoing discussion for efficiently determining the reduced matrices, and thereby Λ_{L} and P_{L}, has been specialized to level-L for convenience and notational clarity. The modifications required to determine Λₗ and Pₗ from Zₗ₊₁^{(NN)} for l<L are straightforward and will not be explicitly indicated (the required changes amount to changing subscript labels, etc.).

7 Summary of Multilevel Factorization Algorithm

FIG. 7 summarizes the discussion of previous sections by indicating the flow of the multilevel LOGOS-based factorization procedure for the MLSSM representation of the impedance matrix. Given an input MLSSM representation of Z, the factorization algorithm indicated in FIG. 7 recursively finds the overlapping LOGOS modes for the Zₗ₊₁^{(NN)} submatrices using the algorithm discussed in Section 6. These modes are used to form the sparse transformation (Λₗ) and projection (Pₗ) matrices, which are subsequently used to project Zₗ₊₁^{(NN)} into the submatrices Zₗ^{(NN)} and Zₗ^{(LN)} of (7) using the MLSSM-based procedure discussed in Section 6.2. The submatrices Zₗ^{(LN)} are stored for use in the back substitution procedure discussed in Section 8, and the foregoing procedure is repeated for Zₗ^{(NN)} at the next coarser level of the quad tree. Finally, when the primary loop has finished, the remaining matrix, Z₃^{(NN)}, is inverted using a standard LU decomposition.

7.1 Complexity Estimate

It has been observed (via the numerical implementation reported in Section 9) that the CPU cost of the algorithm proposed in FIG. 7 is dominated at low frequencies by the computation of overlapped modes at level-L of the quad tree. Therefore, we estimate the overall computational complexity of the proposed factorization algorithm by estimating the cost to determine the level-L OLL modes.

The cost to compute the OLL modes at level-L can be decomposed into three components. These components and their estimated complexities follow.
1. Cost to build all of the X_{l,P(l,i(L))}.
We begin by recalling that the X_{l,P(l,i(L))} define the interactions between the level-l parents of sources in the set {i(L),n} and on-near-neighbor level-l observers that could not be represented at a coarser level. Due to the redundancies indicated in Section 6.3.4, the number of unique X_{l,P(l,i(L))} to be calculated scales as O(N). Furthermore, our assumption of low frequency applications implies that each X_{l,P(l,i(L))} is O(1)×O(1). together, these facts imply that the total cost to store the X_{l,P(l,i(L))} will scale as O(N) (as indicated in Section 6.3.4, this is consistent with our observations of the numerical implementation reported in Section 9). However, the CPU cost to compute any one of the X_{l,P(l,i(L))} is bounded by O(log N) (and not O(1)). For example, when l≈L, calculation of a single X_{l,P(l,i(LL))} via equation (27) can require up to O(log N) operations due to the need to traverse the multilevel tree. Combining this estimate for the cost to compute a single X_{l,P(l,i(L))} with the fact that there are O(N) such matrices to be computed yields an upper complexity bound for this operation of O(N log N).
2. Cost to compress the \hat{Z}_{{i(L),n}}^{(f)}.
As indicated in item 2b of FIG. 6, each of the \hat{Z}{i(L),n}^{(f)} is obtained by accumulating the A_{l,i(L)}. Since (i) there are O(log N) levels, and (ii) each of the A_{l,i(L)} is O(1-by-O(1), it follows that the SVD-based compression required for each \hat{Z}_{{i(L),n}}^{f)} has a cost of O(log N). Because there are O(N) groups at level-L, the total cost for this operation is O(N log N).
3. Cost to compute LOGOS modes from the Z_{{i(L),n}}^{(r)} .
Because each of the Z_{{i(l),n}}^{r)} is O(1)×O(1), the cost to determine the level-L overlapped localizing LOGOS (OLL) modes from the Z_{{i(L),n}}^{(r)} for a single group, i(L), is O(1). Since there are O(N) such groups, the total CPU cost required to determine all level-L OLL modes given the Z_{{i(L),n}}^{(r)} is O(N).
   Together these estimates indicate that the CPU cost to determine the level-L OLL modes from the MLSSM representation of Z is O(N log N). Because (i) the time to determine LOGOS modes always dominates the total CPU time, and (ii) the time to determine LOGOS modes for each projection of the impedance matrix, Zᵢ₊₁^{(NN)}, decreases rapidly with l, we conclude that this estimate (i.e., O(N log N)) for the cost to determine the level-L OLL modes also bounds the total CPU complexity of the proposed factorization algorithm. This (non rigorous) estimate is evaluated in Section 9 through a comparison with numerical data.
   8 Sparse Implementation of Z⁻¹

The LOGOS-based factored representation of the impedance matrix yields the following sparse algorithm for implementing J=−Z⁻¹Eⁱ.
1. For l=L:−1:3, use the projection matrices, Pₗ, to compute:

$$[ \begin{matrix}{E}_{l}^{( L )} \\ {E}_{l}^{( N )}\end{matrix} ] = {[ {P}_{l}^{( L )} , {P}_{l}^{( N )} ]}^{H} {E}_{l + 1}^{( N )} , \qquad ( 29 )$$
where E_{L+1}^{(N)}≡−Eⁱ. due to its recursive form, the level-l quantities on the left side of (29) can be stored in the memory space initially used to store Eₗ₊₁^{(N)} on the right side of the equation. The indicated recursion terminates when l=3, by which point the memory initially used to store the incident vector is replaced by the transformed quantity \tilde{E},
   Eⁱz,1 \tilde{E}=[E_{L}^{(L),}E_{L-1}^{(L)}, . . . , E₃^{(L)},E₃^{(N)}]^{I} (30)
   The elements of \tilde{E} are the projections of the incident field onto the fields scattered by the overlapped, localizing modes at levels L through 3. The final portion of \tilde{E}, E₃^{(N)}, represents the projection of the incident field onto the scattered fields associated with modes which could not be localized at levels l≧3.
2. The back substitution procedure continues with the calculation of the quantity
   J₃^{(N)}=(Z₃^{(NN)})⁻¹E₃^{(N)}, (31)
where E₃^{(N)} is extracted from \tilde{E} in (30). The inverse operation in (31) is performed using a standard LU decomposition.
3. Given (30) and (31), the entire solution vector is obtained via back substitution. For l=3:L:

$${J}_{l + 1} = [ \begin{matrix}{J}_{l + 1}^{( L )} \\ {J}_{l + 1}^{( N )}\end{matrix} ] = {Λ}_{l} [ \begin{matrix}{E}_{l}^{( N )} - {Z}_{l}^{( L N )} {J}_{l}^{( N )} \\ {J}_{l}^{( N )}\end{matrix} ] , \qquad ( 32 )$$
4. The desired solution vector is J=−Z⁻¹Eⁱ≈J_{L+1}.
   The solution procedure indicated by (29) through (32) is used in the following mumerical examples set forth by way of example in EXHIBIT C under the section of text entitled:
   9 Numerical Examples.

### EXAMPLE 1.5

### Example Application (Covers 4 Pages)

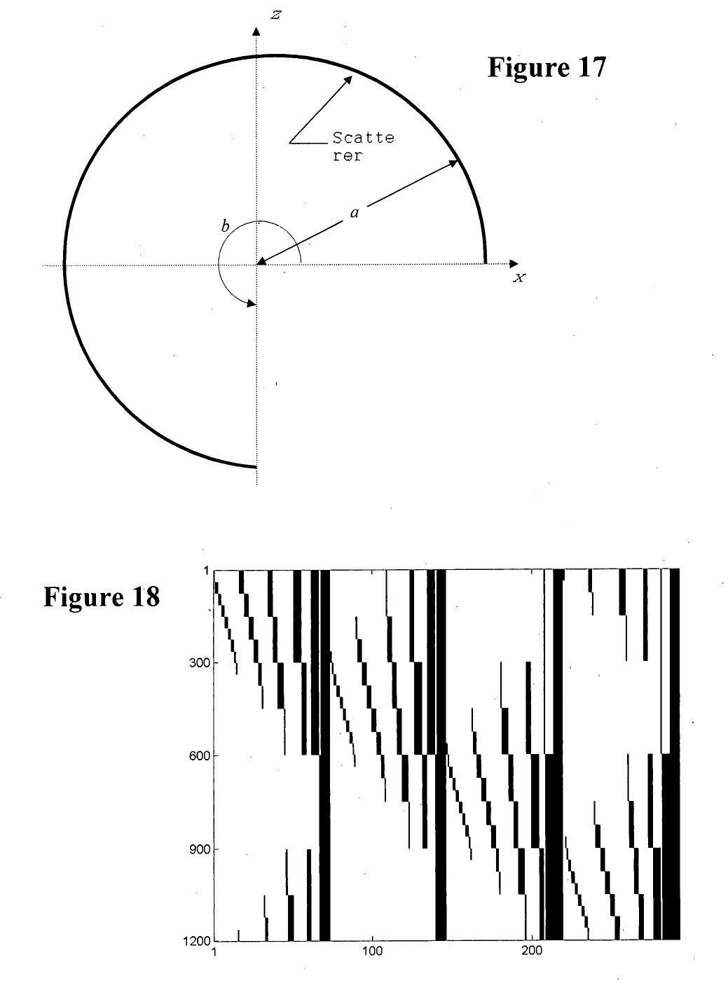

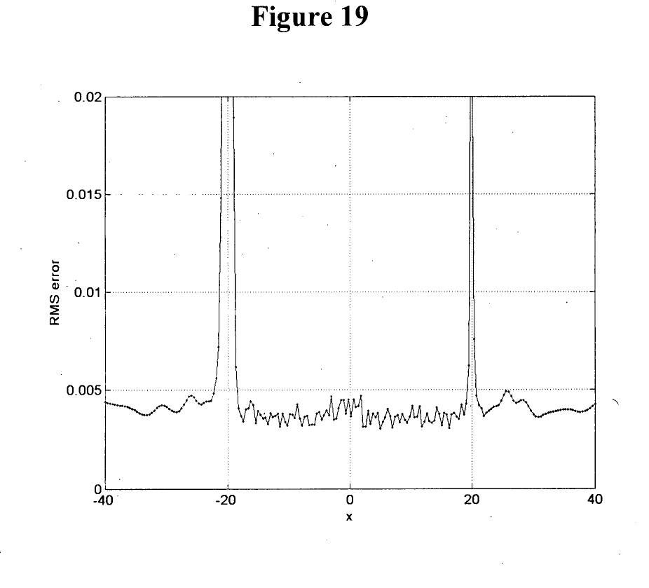

Expressions/equations are numbered consecutively within EXAMPLE 1.5 independently from the other EXAMPLES 1, 1.2, 1.3, and 1.4, and referenced as set forth, below. Over the next four pages of this Example 1.5, reference is made to a “FIG. 1” which is FIG. 16 hereof: A depiction of the general structure of transformed PWT operator, ΛD₀. Solid black colored sections indicate nonzero matrix entries. Four small blocks are the result of electrical current modes which radiate to one of four angular regions. Wider blocks correspond to current modes which radiate to larger angular regions.

Introduction

Numerical solutions of surface integral equation formulations of time-harmonic TMz electromagnetic interactions with perfect electric conductors (PECs) require solving linear systems of the form
E_{z}ⁱ+ZJ=0, (1)
where Z is the N-by-N impedance matrix, the vector J, contains the coefficients of the basis functions used to represent the electric currents on the conductor, and the vector E_{z}ⁱ is determined by samples of an impressed electric field.
The P-Matrix
In many cases of practical interest, the incident electric field can be expanded as a sum of propagating plane weaves arriving from infinity:

$${E}_{z}^{ⅈ} ( ρ ) = \frac{1}{2 π} {\int }_{2 π} {ⅇ}^{jk \cdot ρ} {f}^{ⅈ} ( ϕ ) ⅆ ϕ , \qquad ( 2 )$$

where k=k(\hat{x}cosφ+ŷsin φ), k=2π/λ, and ƒⁱ(φ) is the plane wave spectrum of the incident field. In the following we denote the discrete form of (2) as
E_{z}ⁱ=Dfⁱ, (3)
where D is a discrete representation of the continuous plane wave transform appearing in (2). The PWT matrix D maps an incident spectrum of plane waves to the corresponding incident currents on the surface of a target.
For the class of problems to which (2) applies, equation (1) can be written
ZJ_{z}=−Dfⁱ (4)
Assuming that Z is invertible, the desired solution is
J_{z}=Z⁻¹Dfⁱ=Pfⁱ, (5)
where P=Z⁻¹d is the spectral solution operator which specifies the coefficients of the surface current approximation excited by a weighted sum of incident plane waves. For convenience, P is referred to as the plane wave response matrix (P-matrix).

It has been observed that so-called local-global solution (LOGOS) modes can be used to determine sparse representations of P [1, 2]. The availability of sparse direct representations of the spectral solution operator leads naturally to the question of whether this result might be used to determine sparse direct representations of Z⁻¹. In this direction, we observed that the solution to (1) can be obtained via (5) provided that, for a given Eⁱ, one is able to determine a spectral excitation fⁱ satisfying (3). The solution with the minimum error in satisfying (3) can be represented as
fⁱ=D⁺E_{z}ⁱ, (6)
where D⁺ denotes the pseudo inverse of the PWT.

Using (6) in (5) provides the desired approximation for Z⁻¹:
Z⁻¹E_{z}ⁱ≈P D⁺E_{z}ⁱ (7)
In practice, the quality of the approximation (7) will depend on the accuracy with which (6) satisfies (3). It was observed in [1] that (7) can be used to determine accurate solutions for finite excitations located inside simple cavities. To be practically useful in such cases, it is necessary to determine efficient implementations of D⁺.
Sparse Representation of PWT

Consider the problem of TMz scattering from a circular cylinder having radius α. Let the points on the circular contour be divided into M spatial groups. We would like to determine a sparse representation of D by expanding its range in current modes localized to the M spatial groups, each radiating to distinct angular regions of successively larger size. A complication of this approach is that each of the M spatial groups generally contains an effectively open subsection of the original surface. Because the surface is open, it is generally not possible to determine current modes which radiate to a single angular region.

For this reason, we completely enclose each of the M spatial regions in a small rectangular box and define an intermediate transformation, D₀, which maps an incident plane wave spectrum into fields on the surface of each small box. the original PWT is obtained via the relation
D=BD₀, (8)
where B is the block diagonal operator which maps from fields on the surface of each equivalence box to the incident electric field on the actual target.

It is not possible to determine a sparse representation of D₀ (B is already sparse) by expanding its range in current modes localized to the M equivalence boxes, each radiating to distinct angular regions of successively larger size. (The numerical procedure used to compute these modes is essentially similar to that previously reported elsewhere [3].) Let the matrix Λ denote the block diagonal matrix obtained by collecting these modes. It follows that
D₀≈Λ⁻¹(ΛD₀) (9)
provides a sparse representation of D₀. (The indicated approximation results from truncating the rows of ΛD₀.) The corresponding sparse representation of D is
D=BD₀≈(BΛ⁻¹)(ΛD₀) (10)
Sparse Factorization of PWT

FIG. 1 illustrates the general structure of the term ΛD₀ appearing on the right side of (10). The matrix BΛ⁻¹ is a permutation of a (rectangular) block diagonal matrix and is not shown. Denote the O(ε) QR factorizations for these operators as follows:
BΛ⁻¹=QₗR₁
(ΛD₀)^{H}=QᵣRᵣ (11)
It is straightforward to show that all operators on the right side of (11) are sparse [3]. This permits (10) to be written as
D≈Qₗ(RₗRᵣ^{H})Qᵣ^{H} (12)
The pseudo inverse of the PWT is therefore
D⁺≈Qᵣ(RₗRᵣ^{H})⁺Qₗ^{H} (13)
where we have used the fact that Qᵣ and Qₗ are orthonormal. Finally, because Rₗ and Rᵣ are square we have finally
D⁺≈Qᵣ(Rᵣ^{H})⁻¹Rₗ⁻¹Qₗ^{H} (14)
Equation (14) provides an O(ε) sparse direct representation of the pseudo inverse of the plane wave transform. The required inverses, Rₗ⁻¹ and (Rᵣ^{H})⁻¹, can both be implemented via backward and forward substitution, respectively.

While certain representative embodiments and details have been shown for the purpose of illustrating features of the invention, those skilled in the art will readily appreciate that various modifications, whether specifically or expressly identified herein, may be made to these representative embodiments without departing from the novel core teachings or scope of this technical disclosure. Accordingly, all such modifications are intended to be included within the scope of the claims. Although the commonly employed preamble phrase “comprising the steps of” may be used herein, or hereafter, in a method claim, the applicants do not intend to invoke 35 U.S.C. §112 ¶ 6 in a manner that unduly limits rights to its innovation. Furthermore, in any claim that is filed herewith or hereafter, any means-plus-function clauses used, or later found to be present, are intended to cover at least all structure(s) described herein as performing the recited function and not only structural equivalents but also equivalent structures.

What is claimed is:

1. In a method for obtaining a direct solution of a linear system of equations, employing a computerized device, a routine that comprises the steps of:
using a plurality of solution modes, J, that are localized to a subdomain of a larger simulation domain, the plurality of solution modes also satisfying an original system equation of the form: ZJ=Eⁱ, where Z represents an impedance matrix, and Eⁱ represents a forcing vector.

2. The method of claim 1, wherein the routine further comprises the step of:
using a basis of local solutions that satisfy the original system equation, ZJ=Eⁱ, to obtain a plurality of compressed representations of solution operators comprising a product of matrices, (A₁ A₂ . . . Aₙ), wherein each Aᵢ represents a matrix having been derived from information taken from the matrix Z, such that J=(A₁ A_{2 . . . A}ₙ) Eⁱ; the plurality of solution modes, J, having been obtained from a plurality of forcing vectors, Eⁱ.

3. In the method of claim 1, the routine wherein: the plurality of localized solution modes, J, are constrained for a generally non-radiating scenario wherein the solution modes, J, will radiate a negligible amount of energy to a plurality of spatial regions that are both (i) inside a simulation domain, and (ii) outside of a localized spatial region to which the solution modes, J, have been so localized.

4. In the method of claim 3, the routine wherein: each of the plurality of localized solution modes, J, is associated with a respective localized spatial region, and each adjacent region of said respective localized spatial regions, overlap.

5. In the method of claim 3, the routine wherein: each of the plurality of localized solution modes, J, is associated with a respective localized spatial region, and computed from a compressed representation of a full matrix for the original system equation.

6. The method of claim 1 employed for characterizing wave phenomena to aid in the design of a structure around which the wave phenomena will scatter; and wherein the linear system of equations is selected from a group consisting of: a plurality of sparse matrix equations, and a plurality of compressed representations of full matrix equations.

7. The method of claim 6 wherein the wave phenomena that will scatter from the structure is selected from the group consisting of: electromagnetic waves and acoustic waves.

8. In the method of claim 1, the routine wherein the plurality of localized solution modes, J, are constrained for a generally radiating scenario wherein the solution modes, J, will radiate a non-negligible amount of energy to a plurality of spatial regions that are outside of a localized spatial region to which the solution modes, J, have been so localized.

9. In the method of claim 8, the routine wherein: each of a respective field so radiated and associated with a respective of the plurality of localized solution modes, J, is represented using a plurality of plane waves propagating in a plurality of directions.

10. In the method of claim 8, the routine further comprising the step of: using the plurality of localized solution modes, J, to compress a system response, associated with the original system equation, ZJ=Eⁱ, to a plurality of plane wave excitations associated with a wave phenomena.

11. In the method of claim 8, the routine further comprising the step of: using a pseudo-inverse of the discrete plane wave transform, D⁺, to obtain a compressed representation of a system response, associated with the original system equation, ZJ=Eⁱ, to a plurality of plane wave excitations associated with a wave phenomena.

12. In the method of claim 8, the routine further comprising the step of: using a pseudo-inverse of the discrete plane wave, transform, D⁺, to obtain a compressed representation of a system response, associated with the original system equation, ZJ=Eⁱ, to excitations of a wave phenomena.

13. The method of claim 8 employed for characterizing wave phenomena to aid in the design of a structure around which the wave phenomena will scatter; and wherein the wave phenomena that will scatter from the structure is selected from the group consisting of: electromagnetic waves and acoustic waves.

14. A computer executable program code on a computer readable storage medium for use in obtaining a direct solution of a linear system of equations, comprising:
a first program sub-code comprising instructions for using a plurality of solution modes, J, that are localized to a subdomain of a larger simulation domain, the plurality of solution modes also satisfying an original system equation of the form: ZJ=Eⁱ, where Z represents an impedance matrix, and Eⁱ represents a forcing vector.

15. The program code of claim 14 wherein said first program sub-code further comprises instructions for using a basis of local solutions that satisfy the original system equation, ZJ=Eⁱ, to obtain a plurality of compressed representations of solution operators comprising a product of matrices, (A₁ A₂ . . . Aₙ), wherein each Aᵢ represents a matrix having been derived from information taken from the matrix Z, such that J=(A₁ A₂ . . . Aₙ) Eⁱ; the plurality of solution modes, J, having been obtained from a plurality of forcing vectors, Eⁱ.

16. The program code of claim 14: said first program sub-code wherein the plurality of localized solution modes, J, are constrained for a generally non-radiating scenario wherein the solution modes, J, will radiate a negligible amount of energy to a plurality of spatial regions that are both (i) inside a simulation domain, and (ii) outside of a localized spatial region to which the solution modes, J, have been so localized.

17. The program code of claim 14: said first program sub-code wherein the plurality of localized solution modes, J, are constrained for a generally radiating scenario wherein the solution modes, J, will radiate a non-negligible amount of energy to a plurality of spatial regions that are outside of a localized spatial region to which the solution modes, J, have been so localized.

18. The program code of claim 14 wherein said first program sub-code further comprises instructions for using the plurality of localized solution modes, J, to compress a system response, associated with the original system equation, ZJ=Eⁱ, to a plurality of plane wave excitations associated with the wave phenomena.

19. The program code of claim 14 wherein said first program sub-code further comprises instructions for using a pseudo-inverse of the discrete plane wave transform, D⁺, to obtain a compressed representation of a system response, associated with the original system equation, ZJ=Eⁱ, to a plurality of plane wave excitations associated with the wave phenomena.

20. The program code of claim 14 wherein said first program sub-code further comprises instructions for using a pseudo-inverse of the discrete plane wave transform, D⁺, to obtain a compressed representation of a system response, associated with the original system equation, ZJ=Eⁱ, to excitations of the wave phenomena.
